(19) United States
(12) Patent Application Publication
(10) Pub. No.: US 2024/0223760 A1
(43) Pub. Date: Jul. 4, 2024

(54) ADAPTIVE BILATERAL FILTERING FOR VIDEO CODING

(71) Applicant: BEIJING DAJIA INTERNET INFORMATION TECHNOLOGY CO., LTD., Beijing (CN)

(72) Inventors: Ning YAN, San Diego, CA (US); Xiaoyu Xiu, San Diego, CA (US); Yi-Wen Chen, San Diego, CA (US); Che-Wei KUO, San Diego, CA (US); Wei CHEN, San Diego, CA (US); Hong-Jheng JHU, San Diego, CA (US); Xianglin WANG, San Diego, CA (US); Bing Yu, Beijing (CN)

(73) Assignee: BEIJING DAJIA INTERNET INFORMATION TECHNOLOGY CO., LTD., Beijing (CN)

(21) Appl. No.: 18/598,431

(22) Filed: Mar. 7, 2024

Related U.S. Application Data
(63) Continuation of application No. PCT/US22/42679, filed on Sep. 7, 2022.
(60) Provisional application No. 63/241,156, filed on Sep. 7, 2021.

(51) Int. Cl. H04N 19/117; H04N 19/176; H04N 19/82

(52) U.S. Cl. CPC H04N 19/117; H04N 19/176; H04N 19/82

(57) ABSTRACT

Implementations of the disclosure provide a video processing apparatus and method for bilateral filtering in video coding. The video processing method may include receiving, by one or more processors, a reconstructed block for in-loop filtering. The reconstructed block is reconstructed from a video block of a video frame from a video. The video processing method may also include applying, by the one or more processors, a bilateral filtering scheme to the reconstructed block to generate a plurality of bilateral filtering offsets for a plurality of reconstructed samples in the reconstructed block. The video processing method may further include generating, by the one or more processors, a plurality of filtered samples based on the plurality of bilateral filtering offsets. The plurality of filtered samples are used as inputs to subsequent adaptive loop filtering.

### CROSS-REFERENCE TO RELATED APPLICATION

This application is a continuation of PCT Application No. PCT/US/2022/042679, filed Sep. 7, 2022, which is based upon and claims priority to U.S. Provisional Application No. 63/241,156, filed Sep. 7, 2021, both of which are incorporated herein by reference in their entireties.

### TECHNICAL FIELD

This application is related to video coding and compression. More specifically, this application relates to video processing apparatuses and methods for bilateral filtering in video coding.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. For example, video coding standards include Versatile Video Coding (VVC), Joint Exploration test Model (JEM), High-Efficiency Video Coding (HEVC/H.265), Advanced Video Coding (AVC/H.264), Moving Picture Expert Group (MPEG) coding, or the like. Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality.

### SUMMARY

Implementations of the present disclosure provide a video processing method for bilateral filtering in video coding. The video processing method may include receiving, by one or more processors, a reconstructed block for in-loop filtering. The reconstructed block is reconstructed from a video block of a video frame from a video. The video processing method may also include applying, by the one or more processors, a bilateral filtering scheme to the reconstructed block to generate a plurality of bilateral filtering offsets for a plurality of reconstructed samples in the reconstructed block. The video processing method may further include generating, by the one or more processors, a plurality of filtered samples based on the plurality of bilateral filtering offsets. The plurality of filtered samples are used as inputs to subsequent adaptive loop filtering.

Implementations of the present disclosure also provide a video processing apparatus for performing bilateral filtering in video coding. The video processing apparatus may include one or more processors and a memory coupled to the one or more processors. The one or more processors may be configured to receive a reconstructed block for in-loop filtering. The reconstructed block is reconstructed from a video block of a video frame from a video. The one or more processors may also be configured to apply a bilateral filtering scheme to the reconstructed block to generate a plurality of bilateral filtering offsets for a plurality of reconstructed samples in the reconstructed block. The one or more processors may further be configured to generate a plurality of filtered samples based on the plurality of bilateral filtering offsets. The plurality of filtered samples are inputs to subsequent adaptive loop filtering.

Implementations of the present disclosure also provide a non-transitory computer-readable storage medium having stored therein instructions which, when executed by one or more processors, cause the one or more processors to perform a video processing method for bilateral filtering in video coding. The video processing method may include receiving a reconstructed block for in-loop filtering. The reconstructed block is reconstructed from a video block of a video frame from a video. The video processing method may also include applying a bilateral filtering scheme to the reconstructed block to generate a plurality of bilateral filtering offsets for a plurality of reconstructed samples in the reconstructed block. The video processing method may further include generating a plurality of filtered samples based on the plurality of bilateral filtering offsets. The plurality of filtered samples are inputs to subsequent adaptive loop filtering. The video is stored in the non-transitory computer-readable storage medium.

It is to be understood that both the foregoing general description and the following detailed description are examples only and are not restrictive of the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a block diagram illustrating an exemplary system for encoding and decoding video blocks in accordance with some implementations of the present disclosure.

FIG. 2 is a block diagram illustrating an exemplary video encoder in accordance with some implementations of the present disclosure.

FIG. 3 is a block diagram illustrating an exemplary video decoder in accordance with some implementations of the present disclosure.

FIGS. 4A through 4E are graphical representations illustrating how a frame is recursively partitioned into multiple video blocks of different sizes and shapes in accordance with some implementations of the present disclosure.

FIG. 5 is an illustration of an exemplary filter shape for bilateral filtering in accordance with some examples.

FIG. 6 is a block diagram illustrating an exemplary bilateral filtering scheme in accordance with some implementations of the present disclosure.

FIG. 7 is a flow chart of an exemplary method for bilateral filtering in video coding in accordance with some implementations of the present disclosure.

FIG. 8 is a flow chart of an exemplary method for performing an adaptive bilateral filtering scheme to a reconstructed block in accordance with some implementations of the present disclosure.

FIG. 9 is a flow chart of an exemplary method for performing a position-dependent bilateral filtering scheme to a reconstructed block in accordance with some implementations of the present disclosure.

FIG. 10 is a flow chart of an exemplary method for performing a classification-based bilateral filtering scheme to a reconstructed block in accordance with some implementations of the present disclosure.

FIG. 11 is a flow chart of an exemplary method for deriving a look-up table (LUT) adaptively using a least-square method in accordance with some implementations of the present disclosure.

FIG. 12 is a block diagram illustrating a computing environment coupled with a user interface in accordance with some implementations of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with digital video capabilities.

It should be illustrated that the terms “first,” “second,” and the like used in the description, claims of the present disclosure, and the accompanying drawings are used to distinguish objects, and not used to describe any specific order or sequence. It should be understood that the data used in this way may be interchanged under an appropriate condition, such that the embodiments of the present disclosure described herein may be implemented in orders besides those shown in the accompanying drawings or described in the present disclosure.

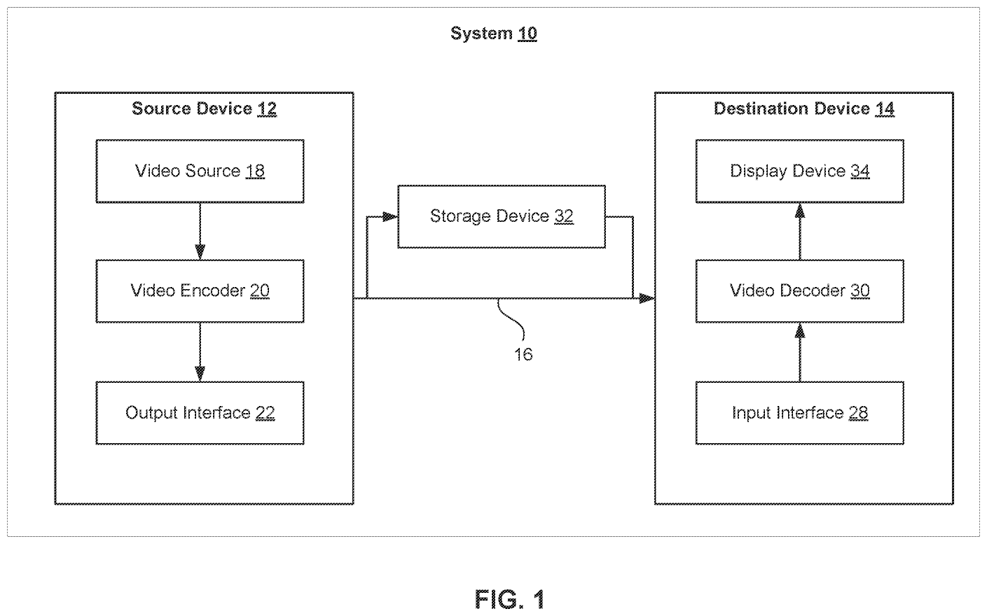

FIG. 1 is a block diagram illustrating an exemplary system 10 for encoding and decoding video blocks in parallel in accordance with some implementations of the present disclosure. As shown in FIG. 1, the system 10 includes a source device 12 that generates and encodes video data to be decoded at a later time by a destination device 14. The source device 12 and the destination device 14 may include any of a wide variety of electronic devices, including desktop or laptop computers, tablet computers, smart phones, set-top boxes, digital televisions, cameras, display devices, digital media players, video gaming consoles, video streaming device, or the like. In some implementations, the source device 12 and the destination device 14 are equipped with wireless communication capabilities.

In some implementations, the destination device 14 may receive the encoded video data to be decoded via a link 16. The link 16 may include any type of communication medium or device capable of forwarding the encoded video data from the source device 12 to the destination device 14. In one example, the link 16 may include a communication medium to enable the source device 12 to transmit the encoded video data directly to the destination device 14 in real time. The encoded video data may be modulated according to a communication standard, such as a wireless communication protocol, and transmitted to the destination device 14. The communication medium may include any wireless or wired communication medium, such as a Radio Frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 12 to the destination device 14.

In some other implementations, the encoded video data may be transmitted from an output interface 22 to a storage device 32. Subsequently, the encoded video data in the storage device 32 may be accessed by the destination device 14 via an input interface 28. The storage device 32 may include any of a variety of distributed or locally accessed data storage media such as a hard drive, Blu-ray discs, Digital Versatile Disks (DVDs), Compact Disc Read-Only Memories (CD-ROMs), flash memory, volatile or non-volatile memory, or any other suitable digital storage media for storing the encoded video data. In a further example, the storage device 32 may correspond to a file server or another intermediate storage device that may store the encoded video data generated by the source device 12. The destination device 14 may access the stored video data from the storage device 32 via streaming or downloading. The file server may be any type of computer capable of storing the encoded video data and transmitting the encoded video data to the destination device 14. Exemplary file servers include a web server (e.g., for a website), a File Transfer Protocol (FTP) server, Network Attached Storage (NAS) devices, or a local disk drive. The destination device 14 may access the encoded video data through any standard data connection, including a wireless channel (e.g., a Wireless Fidelity (Wi-Fi) connection), a wired connection (e.g., Digital Subscriber Line (DSL), cable modem, etc.), or any combination thereof that is suitable for accessing encoded video data stored on a file server. The transmission of the encoded video data from the storage device 32 may be a streaming transmission, a download transmission, or a combination of both.

As shown in FIG. 1, the source device 12 includes a video source 18, a video encoder 20, and the output interface 22. The video source 18 may include a source such as a video capturing device, e.g., a video camera, a video archive containing previously captured video, a video feeding interface to receive video data from a video content provider, and/or a computer graphics system for generating computer graphics data as the source video, or a combination of such sources. As one example, if the video source 18 is a video camera of a security surveillance system, the source device 12 and the destination device 14 may include camera phones or video phones. However, the implementations described in the present disclosure may be applicable to video coding in general, and may be applied to wireless and/or wired applications.

The captured, pre-captured, or computer-generated video may be encoded by the video encoder 20. The encoded video data may be transmitted directly to the destination device 14 via the output interface 22 of the source device 12. The encoded video data may also (or alternatively) be stored onto the storage device 32 for later access by the destination device 14 or other devices, for decoding and/or playback. The output interface 22 may further include a modem and/or a transmitter.

The destination device 14 includes the input interface 28, a video decoder 30, and a display device 34. The input interface 28 may include a receiver and/or a modem and receive the encoded video data over the link 16. The encoded video data communicated over the link 16, or provided on the storage device 32, may include a variety of syntax elements generated by the video encoder 20 for use by the video decoder 30 in decoding the video data. Such syntax elements may be included within the encoded video data transmitted on a communication medium, stored on a storage medium, or stored on a file server.

In some implementations, the destination device 14 may include the display device 34, which can be an integrated display device and an external display device that is configured to communicate with the destination device 14. The display device 34 displays the decoded video data for a user, and may include any of a variety of display devices such as a Liquid Crystal Display (LCD), a plasma display, an Organic Light Emitting Diode (OLED) display, or another type of display device.

The video encoder 20 and the video decoder 30 may operate according to proprietary or industry standards, such as VVC, HEVC, MPEG-4, Part 10, AVC, or extensions of such standards. It should be understood that the present disclosure is not limited to a specific video encoding/decoding standard and may be applicable to other video encoding/decoding standards. It is generally contemplated that the video encoder 20 of the source device 12 may be configured to encode video data according to any of these current or future standards. Similarly, it is also generally contemplated that the video decoder 30 of the destination device 14 may be configured to decode video data according to any of these current or future standards.

The video encoder 20 and the video decoder 30 each may be implemented as any of a variety of suitable encoder and/or decoder circuitry, such as one or more microprocessors, Digital Signal Processors (DSPs), Application Specific Integrated Circuits (ASICs), Field Programmable Gate Arrays (FPGAs), discrete logic, software, hardware, firmware or any combinations thereof. When implemented partially in software, an electronic device may store instructions for the software in a suitable, non-transitory computer-readable medium and execute the instructions in hardware using one or more processors to perform the video encoding/decoding operations disclosed in the present disclosure. Each of the video encoder 20 and the video decoder 30 may be included in one or more encoders or decoders, either of which may be integrated as part of a combined encoder/decoder (CODEC) in a respective device.

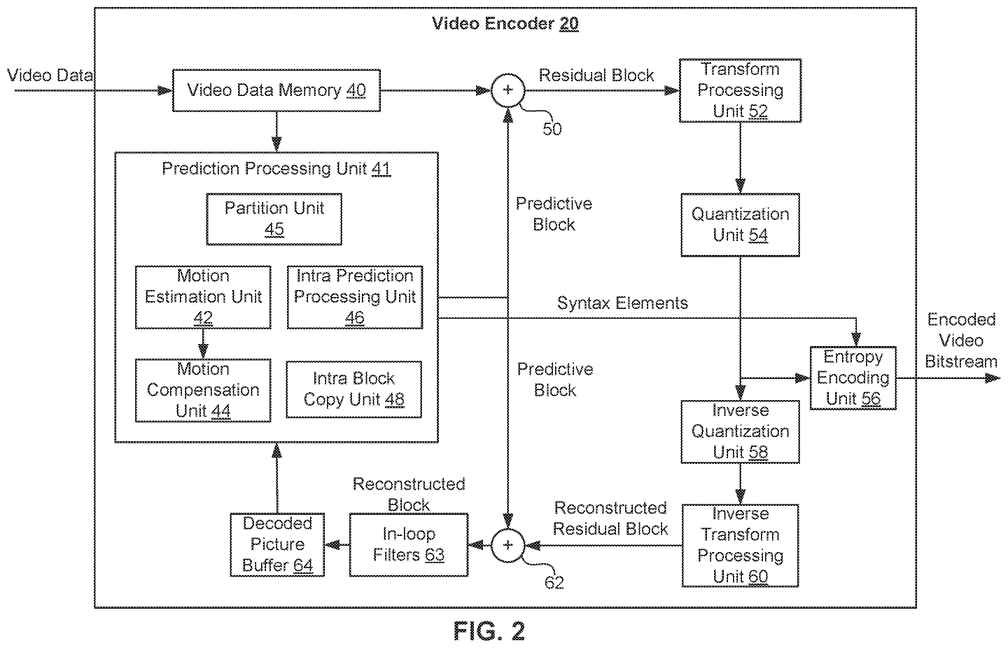

FIG. 2 is a block diagram illustrating an exemplary video encoder 20 in accordance with some implementations described in the present application. The video encoder 20 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence. It should be noted that the term “frame” may be used as synonyms for the term “image” or “picture” in the field of video coding.

As shown in FIG. 2, the video encoder 20 includes a video data memory 40, a prediction processing unit 41, a Decoded Picture Buffer (DPB) 64, a summer 50, a transform processing unit 52, a quantization unit 54, and an entropy encoding unit 56. The prediction processing unit 41 further includes a motion estimation unit 42, a motion compensation unit 44, a partition unit 45, an intra prediction processing unit 46, and an intra Block Copy (BC) unit 48. In some implementations, the video encoder 20 also includes an inverse quantization unit 58, an inverse transform processing unit 60, and a summer 62 for video block reconstruction. An in-loop filter 63, such as a deblocking filter, may be positioned between the summer 62 and the DPB 64 to filter block boundaries to remove block artifacts from reconstructed video data. Another in-loop filter, such as an SAO filter and/or Adaptive in-Loop Filter (ALF), may also be used in addition to the deblocking filter to filter an output of the summer 62. In some examples, the in-loop filters may be omitted, and the decoded video block may be directly provided by the summer 62 to the DPB 64. The video encoder 20 may take the form of a fixed or programmable hardware unit or may be divided among one or more of the illustrated fixed or programmable hardware units.

The video data memory 40 may store video data to be encoded by the components of the video encoder 20. The video data in the video data memory 40 may be obtained, for example, from the video source 18 as shown in FIG. 1. The DPB 64 is a buffer that stores reference video data (for example, reference frames or pictures) for use in encoding video data by the video encoder 20 (e.g., in intra or inter predictive coding modes). The video data memory 40 and the DPB 64 may be formed by any of a variety of memory devices. In various examples, the video data memory 40 may be on-chip with other components of the video encoder 20, or off-chip relative to those components.

As shown in FIG. 2, after receiving the video data, the partition unit 45 within the prediction processing unit 41 partitions the video data into video blocks. This partitioning may also include partitioning a video frame into slices, tiles (for example, sets of video blocks), or other larger Coding Units (CUs) according to predefined splitting structures such as a Quad-Tree (QT) structure associated with the video data. The video frame is or may be regarded as a two-dimensional array or matrix of samples with sample values. A sample in the array may also be referred to as a pixel or a pel. A number of samples in horizontal and vertical directions (or axes) of the array or picture define a size and/or a resolution of the video frame. The video frame may be divided into multiple video blocks by, for example, using QT partitioning. The video block again is or may be regarded as a two-dimensional array or matrix of samples with sample values, although of smaller dimension than the video frame. A number of samples in horizontal and vertical directions (or axes) of the video block define a size of the video block. The video block may further be partitioned into one or more block partitions or sub-blocks (which may form again blocks) by, for example, iteratively using QT partitioning, Binary-Tree (BT) partitioning, Triple-Tree (TT) partitioning or any combination thereof. It should be noted that the term “block” or “video block” as used herein may be a portion, in particular a rectangular (square or non-square) portion, of a frame or a picture. With reference to, for example, HEVC and VVC, the block or video block may be or correspond to a Coding Tree Unit (CTU), a CU, a Prediction Unit (PU), or a Transform Unit (TU), and/or may be or correspond to a corresponding block, e.g., a Coding Tree Block (CTB), a Coding Block (CB), a Prediction Block (PB), or a Transform Block (TB). Alternatively or additionally, the block or video block may be or correspond to a sub-block of a CTB, a CB, a PB, a TB, etc.

The prediction processing unit 41 may select one of a plurality of possible predictive coding modes, such as one of a plurality of intra predictive coding modes or one of a plurality of inter predictive coding modes, for the current video block based on error results (e.g., coding rate and the level of distortion). The prediction processing unit 41 may provide the resulting intra or inter prediction coded block (e.g., a predictive block) to the summer 50 to generate a residual block and to the summer 62 to reconstruct the encoded block for use as part of a reference frame subsequently. The prediction processing unit 41 also provides syntax elements, such as motion vectors, intra-mode indicators, partition information, and other such syntax information to the entropy encoding unit 56.

In order to select an appropriate intra predictive coding mode for the current video block, the intra prediction processing unit 46 within the prediction processing unit 41 may perform intra predictive coding of the current video block relative to one or more neighbor blocks in the same frame as the current block to be coded to provide spatial prediction. The motion estimation unit 42 and the motion compensation unit 44 within the prediction processing unit 41 perform inter predictive coding of the current video block relative to one or more predictive blocks in one or more reference frames to provide temporal prediction. The video encoder 20 may perform multiple coding passes, e.g., to select an appropriate coding mode for each block of video data.

In some implementations, the motion estimation unit 42 determines the inter prediction mode for a current video frame by generating a motion vector, which indicates the displacement of a video block within the current video frame relative to a predictive block within a reference frame, according to a predetermined pattern within a sequence of video frames. Motion estimation, performed by the motion estimation unit 42, may be a process of generating motion vectors, which may estimate motion for video blocks. A motion vector, for example, may indicate the displacement of a video block within a current video frame or picture relative to a predictive block within a reference frame. The predetermined pattern may designate video frames in the sequence as P frames or B frames. The intra BC unit 48 may determine vectors, e.g., block vectors, for intra BC coding in a manner similar to the determination of motion vectors by the motion estimation unit 42 for inter prediction, or may utilize the motion estimation unit 42 to determine the block vectors.

A predictive block for the video block may be or may correspond to a block or a reference block of a reference frame that is deemed as closely matching the video block to be coded in terms of pixel difference, which may be determined by Sum of Absolute Difference (SAD), Sum of Square Difference (SSD), or other difference metrics. In some implementations, the video encoder 20 may calculate values for sub-integer pixel positions of reference frames stored in the DPB 64. For example, the video encoder 20 may interpolate values of one-quarter pixel positions, one-eighth pixel positions, or other fractional pixel positions of the reference frame. Therefore, the motion estimation unit 42 may perform a motion search relative to the full pixel positions and fractional pixel positions and output a motion vector with fractional pixel precision.

The motion estimation unit 42 calculates a motion vector for a video block in an inter prediction coded frame by comparing the position of the video block to the position of a predictive block of a reference frame selected from a first reference frame list (List 0) or a second reference frame list (List 1), each of which identifies one or more reference frames stored in the DPB 64. The motion estimation unit 42 sends the calculated motion vector to the motion compensation unit 44 and then to the entropy encoding unit 56.

Motion compensation, performed by the motion compensation unit 44, may involve fetching or generating the predictive block based on the motion vector determined by the motion estimation unit 42. Upon receiving the motion vector for the current video block, the motion compensation unit 44 may locate a predictive block to which the motion vector points in one of the reference frame lists, retrieve the predictive block from the DPB 64, and forward the predictive block to the summer 50. The summer 50 then forms a residual block of pixel difference values by subtracting pixel values of the predictive block provided by the motion compensation unit 44 from the pixel values of the current video block being coded. The pixel difference values forming the residual block may include luma or chroma component differences or both. The motion compensation unit 44 may also generate syntax elements associated with the video blocks of a video frame for use by the video decoder 30 in decoding the video blocks of the video frame. The syntax elements may include, for example, syntax elements defining the motion vector used to identify the predictive block, any flags indicating the prediction mode, or any other syntax information described herein. It is noted that the motion estimation unit 42 and the motion compensation unit 44 may be integrated together, which are illustrated separately for conceptual purposes in FIG. 2.

In some implementations, the intra BC unit 48 may generate vectors and fetch predictive blocks in a manner similar to that described above in connection with the motion estimation unit 42 and the motion compensation unit 44, but with the predictive blocks being in the same frame as the current block being coded and with the vectors being referred to as block vectors as opposed to motion vectors. In particular, the intra BC unit 48 may determine an intra-prediction mode to use to encode a current block. In some examples, the intra BC unit 48 may encode a current block using various intra-prediction modes, e.g., during separate encoding passes, and test their performance through rate-distortion analysis. Next, the intra BC unit 48 may select, among the various tested intra-prediction modes, an appropriate intra-prediction mode to use and generate an intra-mode indicator accordingly. For example, the intra BC unit 48 may calculate rate-distortion values using a rate-distortion analysis for the various tested intra-prediction modes, and select the intra-prediction mode having the best rate-distortion characteristics among the tested modes as the appropriate intra-prediction mode to use. Rate-distortion analysis generally determines an amount of distortion (or error) between an encoded block and an original, unencoded block that was encoded to produce the encoded block, as well as a bitrate (i.e., a number of bits) used to produce the encoded block. Intra BC unit 48 may calculate ratios from the distortions and rates for the various encoded blocks to determine which intra-prediction mode exhibits the best rate-distortion value for the block.

In other examples, the intra BC unit 48 may use the motion estimation unit 42 and the motion compensation unit 44, in whole or in part, to perform such functions for Intra BC prediction according to the implementations described herein. In either case, for intra block copy, a predictive block may be a block that is deemed as closely matching the block to be coded, in terms of pixel difference, which may be determined by SAD, SSD, or other difference metrics, and identification of the predictive block may include calculation of values for sub-integer pixel positions.

Whether the predictive block is from the same frame according to intra prediction, or from a different frame according to inter prediction, the video encoder 20 may form a residual block by subtracting pixel values of the predictive block from the pixel values of the current video block being coded, forming pixel difference values. The pixel difference values forming the residual block may include both luma and chroma component differences.

The intra prediction processing unit 46 may intra-predict a current video block, as an alternative to the inter-prediction performed by the motion estimation unit 42 and the motion compensation unit 44, or the intra block copy prediction performed by the intra BC unit 48, as described above. In particular, the intra prediction processing unit 46 may determine an intra prediction mode to use to encode a current block. For example, the intra prediction processing unit 46 may encode a current block using various intra prediction modes, e.g., during separate encoding passes, and the intra prediction processing unit 46 (or a mode selection unit, in some examples) may select an appropriate intra prediction mode to use from the tested intra prediction modes. The intra prediction processing unit 46 may provide information indicative of the selected intra-prediction mode for the block to the entropy encoding unit 56. The entropy encoding unit 56 may encode the information indicating the selected intra-prediction mode in a bitstream.

After the prediction processing unit 41 determines the predictive block for the current video block via either inter prediction or intra prediction, the summer 50 forms a residual block by subtracting the predictive block from the current video block. The residual video data in the residual block may be included in one or more TUs and is provided to the transform processing unit 52. The transform processing unit 52 transforms the residual video data into transform coefficients using a transform, such as a Discrete Cosine Transform (DCT) or a conceptually similar transform.

The transform processing unit 52 may send the resulting transform coefficients to the quantization unit 54. The quantization unit 54 quantizes the transform coefficients to further reduce the bit rate. The quantization process may also reduce the bit depth associated with some or all of the coefficients. The degree of quantization may be modified by adjusting a quantization parameter. In some examples, the quantization unit 54 may then perform a scan of a matrix including the quantized transform coefficients. Alternatively, the entropy encoding unit 56 may perform the scan.

Following quantization, the entropy encoding unit 56 may use an entropy encoding technique to encode the quantized transform coefficients into a video bitstream, e.g., using Context Adaptive Variable Length Coding (CAVLC), Context Adaptive Binary Arithmetic Coding (CABAC), Syntax-based context-adaptive Binary Arithmetic Coding (SBAC), Probability Interval Partitioning Entropy (PIPE) coding, or another entropy encoding methodology or technique. The encoded bitstream may then be transmitted to the video decoder 30 as shown in FIG. 1 or archived in the storage device 32 as shown in FIG. 1 for later transmission to or retrieval by the video decoder 30. The entropy encoding unit 56 may also use an entropy encoding technique to encode the motion vectors and the other syntax elements for the current video frame being coded.

The inverse quantization unit 58 and the inverse transform processing unit 60 apply inverse quantization and inverse transformation, respectively, to reconstruct the residual block in the pixel domain for generating a reference block for prediction of other video blocks. A reconstructed residual block may be generated thereof. As noted above, the motion compensation unit 44 may generate a motion compensated predictive block from one or more reference blocks of the frames stored in the DPB 64. The motion compensation unit 44 may also apply one or more interpolation filters to the predictive block to calculate sub-integer pixel values for use in motion estimation.

The summer 62 adds the reconstructed residual block to the motion compensated predictive block produced by the motion compensation unit 44 to produce a reference block for storage in the DPB 64. The reference block may then be used by the intra BC unit 48, the motion estimation unit 42, and the motion compensation unit 44 as a predictive block to inter predict another video block in a subsequent video frame.

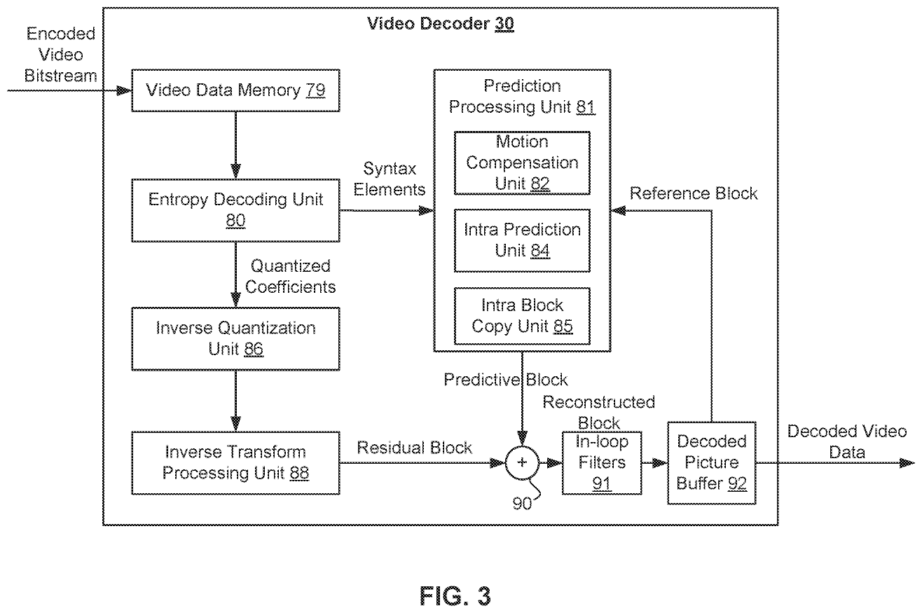

FIG. 3 is a block diagram illustrating an exemplary video decoder 30 in accordance with some implementations of the present application. The video decoder 30 includes a video data memory 79, an entropy decoding unit 80, a prediction processing unit 81, an inverse quantization unit 86, an inverse transform processing unit 88, a summer 90, and a DPB 92. The prediction processing unit 81 further includes a motion compensation unit 82, an intra prediction unit 84, and an intra BC unit 85. The video decoder 30 may perform a decoding process generally reciprocal to the encoding process described above with respect to the video encoder 20 in connection with FIG. 2. For example, the motion compensation unit 82 may generate prediction data based on motion vectors received from the entropy decoding unit 80, while the intra prediction unit 84 may generate prediction data based on intra-prediction mode indicators received from the entropy decoding unit 80.

In some examples, a unit of the video decoder 30 may be tasked to perform the implementations of the present application. Also, in some examples, the implementations of the present disclosure may be divided among one or more of the units of the video decoder 30. For example, the intra BC unit 85 may perform the implementations of the present application, alone, or in combination with other units of the video decoder 30, such as the motion compensation unit 82, the intra prediction unit 84, and the entropy decoding unit 80. In some examples, the video decoder 30 may not include the intra BC unit 85 and the functionality of intra BC unit 85 may be performed by other components of the prediction processing unit 81, such as the motion compensation unit 82.

The video data memory 79 may store video data, such as an encoded video bitstream, to be decoded by the other components of the video decoder 30. The video data stored in the video data memory 79 may be obtained, for example, from the storage device 32, from a local video source, such as a camera, via wired or wireless network communication of video data, or by accessing physical data storage media (e.g., a flash drive or hard disk). The video data memory 79 may include a Coded Picture Buffer (CPB) that stores encoded video data from an encoded video bitstream. The DPB 92 of the video decoder 30 stores reference video data for use in decoding video data by the video decoder 30 (e.g., in intra or inter predictive coding modes). The video data memory 79 and the DPB 92 may be formed by any of a variety of memory devices, such as dynamic random access memory (DRAM), including Synchronous DRAM (SDRAM), Magneto-resistive RAM (MRAM), Resistive RAM (RRAM), or other types of memory devices. For illustrative purpose, the video data memory 79 and the DPB 92 are depicted as two distinct components of the video decoder 30 in FIG. 3. But it will be apparent to one skilled in the art that the video data memory 79 and the DPB 92 may be provided by the same memory device or separate memory devices. In some examples, the video data memory 79 may be on-chip with other components of the video decoder 30, or off-chip relative to those components.

During the decoding process, the video decoder 30 receives an encoded video bitstream that represents video blocks of an encoded video frame and associated syntax elements. The video decoder 30 may receive the syntax elements at the video frame level and/or the video block level. The entropy decoding unit 80 of the video decoder 30 may use an entropy decoding technique to decode the bitstream to obtain quantized coefficients, motion vectors or intra-prediction mode indicators, and other syntax elements. The entropy decoding unit 80 then forwards the motion vectors or intra-prediction mode indicators and other syntax elements to the prediction processing unit 81.

When the video frame is coded as an intra predictive coded (e.g., I) frame or for intra coded predictive blocks in other types of frames, the intra prediction unit 84 of the prediction processing unit 81 may generate prediction data for a video block of the current video frame based on a signaled intra prediction mode and reference data from previously decoded blocks of the current frame.

When the video frame is coded as an inter-predictive coded (i.e., B or P) frame, the motion compensation unit 82 of the prediction processing unit 81 produces one or more predictive blocks for a video block of the current video frame based on the motion vectors and other syntax elements received from the entropy decoding unit 80. Each of the predictive blocks may be produced from a reference frame within one of the reference frame lists. The video decoder 30 may construct the reference frame lists, e.g., List 0 and List 1, using default construction techniques based on reference frames stored in the DPB 92.

In some examples, when the video block is coded according to the intra BC mode described herein, the intra BC unit 85 of the prediction processing unit 81 produces predictive blocks for the current video block based on block vectors and other syntax elements received from the entropy decoding unit 80. The predictive blocks may be within a reconstructed region of the same picture as the current video block processed by the video encoder 20.

The motion compensation unit 82 and/or the intra BC unit 85 determines prediction information for a video block of the current video frame by parsing the motion vectors and other syntax elements, and then uses the prediction information to produce the predictive blocks for the current video block being decoded. For example, the motion compensation unit 82 uses some of the received syntax elements to determine a prediction mode (e.g., intra or inter prediction) used to code video blocks of the video frame, an inter prediction frame type (e.g., B or P), construction information for one or more of the reference frame lists for the frame, motion vectors for each inter predictive encoded video block of the frame, inter prediction status for each inter predictive coded video block of the frame, and other information to decode the video blocks in the current video frame.

Similarly, the intra BC unit 85 may use some of the received syntax elements, e.g., a flag, to determine that the current video block was predicted using the intra BC mode, construction information of which video blocks of the frame are within the reconstructed region and should be stored in the DPB 92, block vectors for each intra BC predicted video block of the frame, intra BC prediction status for each intra BC predicted video block of the frame, and other information to decode the video blocks in the current video frame.

The motion compensation unit 82 may also perform interpolation using the interpolation filters as used by the video encoder 20 during encoding of the video blocks to calculate interpolated values for sub-integer pixels of reference blocks. In this case, the motion compensation unit 82 may determine the interpolation filters used by the video encoder 20 from the received syntax elements and use the interpolation filters to produce predictive blocks.

The inverse quantization unit 86 inversely quantizes the quantized transform coefficients provided in the bitstream and decoded by the entropy decoding unit 80 using the same quantization parameter calculated by the video encoder 20 for each video block in the video frame to determine a degree of quantization. The inverse transform processing unit 88 applies an inverse transform, e.g., an inverse DCT, an inverse integer transform, or a conceptually similar inverse transform process, to the transform coefficients in order to reconstruct the residual blocks in the pixel domain.

After the motion compensation unit 82 or the intra BC unit 85 generates the predictive block for the current video block based on the vectors and other syntax elements, the summer 90 reconstructs a decoded video block for the current video block by summing the residual block from the inverse transform processing unit 88 and a corresponding predictive block generated by the motion compensation unit 82 and the intra BC unit 85. The decoded video block may also be referred to as a reconstructed block for the current video block. An in-loop filter 91 such as a deblocking filter, SAO filter, and/or ALF may be positioned between the summer 90 and the DPB 92 to further process the decoded video block. In some examples, the in-loop filter 91 may be omitted, and the decoded video block may be directly provided by the summer 90 to the DPB 92. The decoded video blocks in a given frame are then stored in the DPB 92, which stores reference frames used for subsequent motion compensation of next video blocks. The DPB 92, or a memory device separate from the DPB 92, may also store decoded video for later presentation on a display device, such as the display device 34 of FIG. 1.

In a typical video coding process (e.g., including a video encoding process and a video decoding process), a video sequence typically includes an ordered set of frames or pictures. Each frame may include three sample arrays, denoted SL, SCb, and SCr. SL is a two-dimensional array of luma samples. SCb is a two-dimensional array of Cb chroma samples. SCr is a two-dimensional array of Cr chroma samples. In other instances, a frame may be monochrome and therefore includes only one two-dimensional array of luma samples.

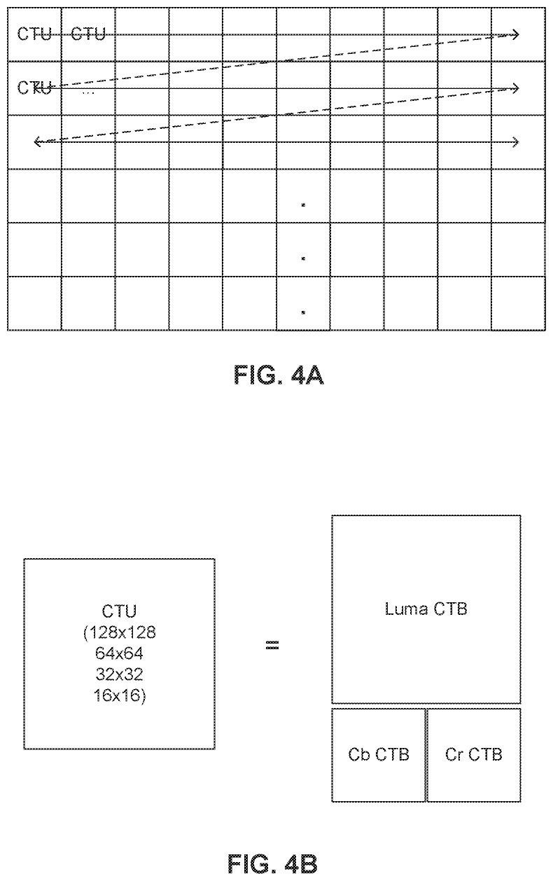

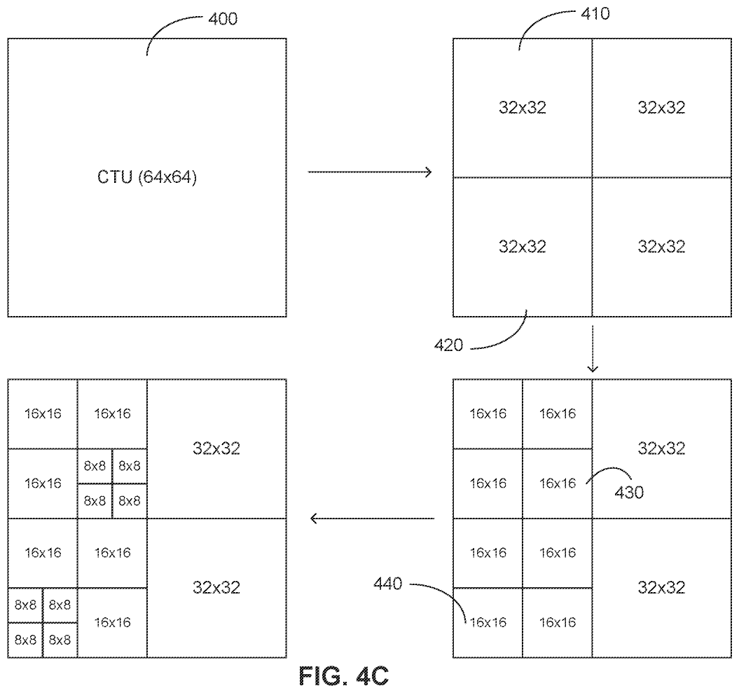

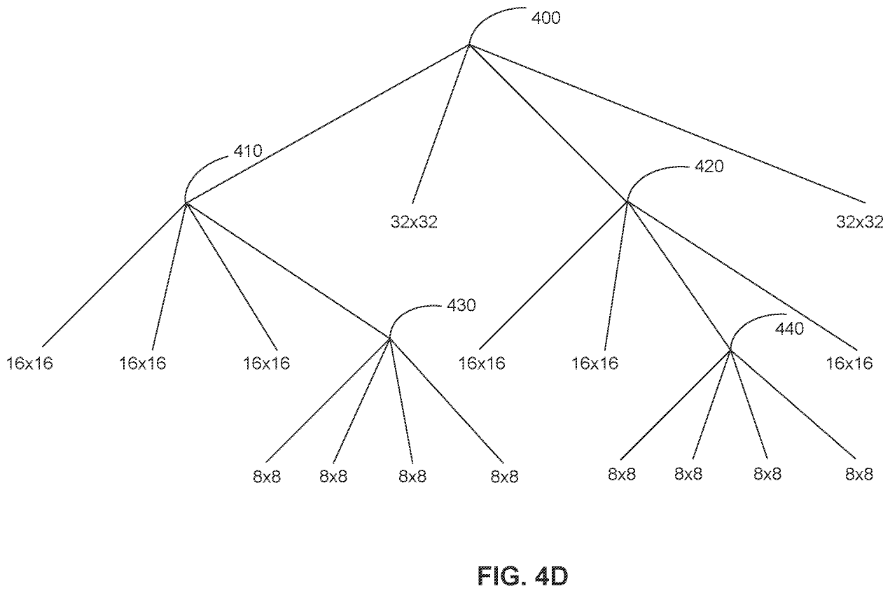

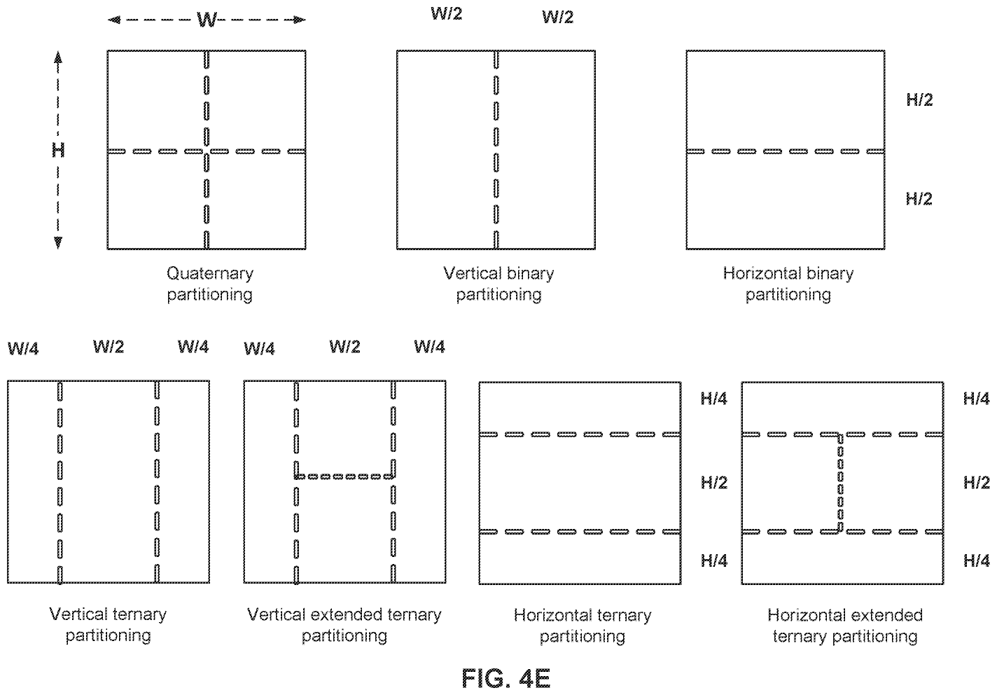

As shown in FIG. 4A, the video encoder 20 (or more specifically the partition unit 45) generates an encoded representation of a frame by first partitioning the frame into a set of CTUs. A video frame may include an integer number of CTUs arranged consecutively in a raster scan order from left to right and from top to bottom. Each CTU is a largest logical coding unit and the width and height of the CTU are signaled by the video encoder 20 in a sequence parameter set, such that all the CTUs in a video sequence have the same size being one of 128×128, 64×64, 32×32, and 16×16. But it should be noted that a CTU in the present disclosure is not necessarily limited to a particular size. As shown in FIG. 4B, each CTU may include one CTB of luma samples, two corresponding coding tree blocks of chroma samples, and syntax elements used to code the samples of the coding tree blocks. The syntax elements describe properties of different types of units of a coded block of pixels and how the video sequence can be reconstructed at the video decoder 30, including inter or intra prediction, intra prediction mode, motion vectors, and other parameters. In monochrome pictures or pictures having three separate color planes, a CTU may include a single coding tree block and syntax elements used to code the samples of the coding tree block. A coding tree block may be an N×N block of samples.

To achieve a better performance, the video encoder 20 may recursively perform tree partitioning such as binary-tree partitioning, ternary-tree partitioning, quad-tree partitioning or a combination thereof on the coding tree blocks of the CTU and divide the CTU into smaller CUs. As depicted in FIG. 4C, the 64×64 CTU 400 is first divided into four smaller CUs, each having a block size of 32×32. Among the four smaller CUs, CU 410 and CU 420 are each divided into four CUs of 16×16 by block size. The two 16×16 CUs 430 and 440 are each further divided into four CUs of 8×8 by block size. FIG. 4D depicts a quad-tree data structure illustrating the end result of the partition process of the CTU 400 as depicted in FIG. 4C, each leaf node of the quad-tree corresponding to one CU of a respective size ranging from 32×32 to 8×8. Like the CTU depicted in FIG. 4B, each CU may include a CB of luma samples and two corresponding coding blocks of chroma samples of a frame of the same size, and syntax elements used to code the samples of the coding blocks. In monochrome pictures or pictures having three separate colour planes, a CU may include a single coding block and syntax structures used to code the samples of the coding block. It should be noted that the quad-tree partitioning depicted in FIGS. 4C and 4D is only for illustrative purposes and one CTU can be split into CUs to adapt to varying local characteristics based on quad/ternary/binary-tree partitions. In the multi-type tree structure, one CTU is partitioned by a quad-tree structure and each quad-tree leaf CU can be further partitioned by a binary and ternary tree structure. As shown in FIG. 4E, there are multiple possible partitioning types of a coding block having a width W and a height H, i.e., quaternary partitioning, vertical binary partitioning, horizontal binary partitioning, vertical ternary partitioning, vertical extended ternary partitioning, horizontal ternary partitioning, and horizontal extended ternary partitioning.

In some implementations, the video encoder 20 may further partition a coding block of a CU into one or more M×N PBs. A PB may include a rectangular (square or non-square) block of samples on which the same prediction, inter or intra, is applied. A PU of a CU may include a PB of luma samples, two corresponding PBs of chroma samples, and syntax elements used to predict the PBs. In monochrome pictures or pictures having three separate color planes, a PU may include a single PB and syntax structures used to predict the PB. The video encoder 20 may generate predictive luma, Cb, and Cr blocks for luma, Cb, and Cr PBs of each PU of the CU.

The video encoder 20 may use intra prediction or inter prediction to generate the predictive blocks for a PU. If the video encoder 20 uses intra prediction to generate the predictive blocks of a PU, the video encoder 20 may generate the predictive blocks of the PU based on decoded samples of the frame associated with the PU. If the video encoder 20 uses inter prediction to generate the predictive blocks of a PU, the video encoder 20 may generate the predictive blocks of the PU based on decoded samples of one or more frames other than the frame associated with the PU.

After the video encoder 20 generates predictive luma, Cb, and Cr blocks for one or more PUs of a CU, the video encoder 20 may generate a luma residual block for the CU by subtracting the CU's predictive luma blocks from its original luma coding block such that each sample in the CU's luma residual block indicates a difference between a luma sample in one of the CU's predictive luma blocks and a corresponding sample in the CU's original luma coding block. Similarly, the video encoder 20 may generate a Cb residual block and a Cr residual block for the CU, respectively, such that each sample in the CU's Cb residual block indicates a difference between a Cb sample in one of the CU's predictive Cb blocks and a corresponding sample in the CU's original Cb coding block, and each sample in the CU's Cr residual block may indicate a difference between a Cr sample in one of the CU's predictive Cr blocks and a corresponding sample in the CU's original Cr coding block.

Furthermore, as illustrated in FIG. 4C, the video encoder 20 may use quad-tree partitioning to decompose the luma, Cb, and Cr residual blocks of a CU into one or more luma, Cb, and Cr transform blocks respectively. A transform block may include a rectangular (square or non-square) block of samples on which the same transform is applied. A TU of a CU may include a transform block of luma samples, two corresponding transform blocks of chroma samples, and syntax elements used to transform the transform block samples. Thus, each TU of a CU may be associated with a luma transform block, a Cb transform block, and a Cr transform block. In some examples, the luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may include a single transform block and syntax structures used to transform the samples of the transform block.

The video encoder 20 may apply one or more transforms to a luma transform block of a TU to generate a luma coefficient block for the TU. A coefficient block may be a two-dimensional array of transform coefficients. A transform coefficient may be a scalar quantity. The video encoder 20 may apply one or more transforms to a Cb transform block of a TU to generate a Cb coefficient block for the TU. The video encoder 20 may apply one or more transforms to a Cr transform block of a TU to generate a Cr coefficient block for the TU.

After generating a coefficient block (e.g., a luma coefficient block, a Cb coefficient block, or a Cr coefficient block), the video encoder 20 may quantize the coefficient block. Quantization generally refers to a process in which transform coefficients are quantized to possibly reduce the amount of data used to represent the transform coefficients, providing further compression. After the video encoder 20 quantizes a coefficient block, the video encoder 20 may apply an entropy encoding technique to encode syntax elements indicating the quantized transform coefficients. For example, the video encoder 20 may perform CABAC on the syntax elements indicating the quantized transform coefficients. Finally, the video encoder 20 may output a bitstream that includes a sequence of bits that form a representation of coded frames and associated data, which is either saved in the storage device 32 or transmitted to the destination device 14.

After receiving a bitstream generated by the video encoder 20, the video decoder 30 may parse the bitstream to obtain syntax elements from the bitstream. The video decoder 30 may reconstruct the frames of the video data based at least in part on the syntax elements obtained from the bitstream. The process of reconstructing the video data is generally reciprocal to the encoding process performed by the video encoder 20. For example, the video decoder 30 may perform inverse transforms on the coefficient blocks associated with TUs of a current CU to reconstruct residual blocks associated with the TUs of the current CU. The video decoder 30 also reconstructs the coding blocks of the current CU by adding the samples of the predictive blocks for PUs of the current CU to corresponding samples of the transform blocks of the TUs of the current CU. After reconstructing the coding blocks for each CU of a frame, video decoder 30 may reconstruct the frame.

As noted above, video coding achieves video compression using primarily two modes, i.e., intra-frame prediction (or intra-prediction) and inter-frame prediction (or inter-prediction). It is noted that intra block copy (IBC) could be regarded as either intra-frame prediction or a third mode. Between the two modes, inter-frame prediction contributes more to the coding efficiency than intra-frame prediction because of the use of motion vectors for predicting a current video block from a reference video block.

But with the ever-improving video data capturing technology and more refined video block size for preserving details in the video data, the amount of data required for representing motion vectors for a current frame also increases substantially. One way of overcoming this challenge is to benefit from the fact that not only a group of neighboring CUs in both the spatial and temporal domains have similar video data for predicting purpose but the motion vectors between these neighboring CUs are also similar. Therefore, it is possible to use the motion information of spatially neighboring CUs and/or temporally co-located CUs as an approximation of the motion information (e.g., motion vector) of a current CU by exploring their spatial and temporal correlation, which is also referred to as “Motion Vector Predictor (MVP)” of the current CU.

Instead of encoding an actual motion vector of the current CU into the video bitstream (e.g., the actual motion vector being determined by the motion estimation unit 42 as described above in connection with FIG. 2), the motion vector predictor of the current CU is subtracted from the actual motion vector of the current CU to produce a Motion Vector Difference (MVD) for the current CU. By doing so, there is no need to encode the motion vector determined by the motion estimation unit 42 for each CU of a frame into the video bitstream, and the amount of data used for representing motion information in the video bitstream can be significantly decreased.

Like the process of choosing a predictive block in a reference frame during inter-frame prediction of a code block, a set of rules can be adopted by both the video encoder 20 and the video decoder 30 for constructing a motion vector candidate list (also known as a “merge list”) for a current CU using those potential candidate motion vectors associated with spatially neighboring CUs and/or temporally co-located CUs of the current CU and then selecting one member from the motion vector candidate list as a motion vector predictor for the current CU. By doing so, there is no need to transmit the motion vector candidate list itself from the video encoder 20 to the video decoder 30, and an index of the selected motion vector predictor within the motion vector candidate list is sufficient for the video encoder 20 and the video decoder 30 to use the same motion vector predictor within the motion vector candidate list for encoding and decoding the current CU. Thus, only the index of the selected motion vector predictor needs to be sent from the video encoder 20 to the video decoder 30.

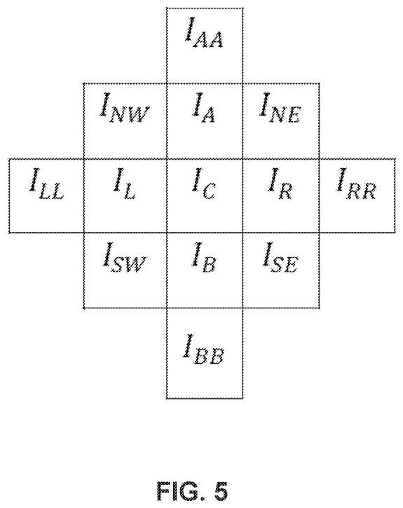

FIG. 5 is an illustration of an exemplary filter shape for bilateral filtering in accordance with some examples. Bilateral filtering is a filtering technique used in video coding. For a filter kernel of the bilateral filtering, the contribution of each sample in a video block depends not only on spatial distances between the samples, but also on the difference in the intensities between the samples. A sample located at a position (i, j) may be filtered using its neighboring sample at a position (k, l) within a filtering window, where the sample (i, j) is a center sample of the filtering window. A weight ω(i, j, k, l) assigned to the sample (k, l) for the filtering of the sample (i, j) can be expressed in the following equation:

$$ω ( i , j , k , l ) = {e}^{- \frac{{( i - k )}^{2} + {( j - l )}^{2}}{2 {σ}_{d}^{2}} - \frac{{( I ( i , j ) - I ( k , l ) )}^{2}}{2 {σ}_{r}^{2}}} . \qquad ( 1 )$$

In the above equation (1), I(i, j) and I(k, l) denotes intensity values of the samples (i, j) and (k, l), respectively. The strength of the bilateral filter is controlled by σ_{d} (representing a spatial strength) and σᵣ (representing an intensity strength). An output sample (e.g., an output filtered sample for the center sample (i, j)) can be a weighted average of the samples inside the filtering window (e.g., with the weights being determined based on the above equation (1), respectively).

In an Enhanced Compression Model (ECM), there can be three in-loop filtering modules, including a de-blocking filter (DBF), a sample adaptive offset (SAO), and an adaptive loop filter (ALF). During the development of the VVC standard, a bilateral filter is initially proposed to refine a reconstructed block after an inverse transform. Later, the application of the bilateral filter is extended to be a part of the in-loop filtering, which can be utilized with SAO jointly as shown in the following equation (2). The bilateral filter creates a bilateral filtering offset per sample, which is added to the corresponding input sample of the bilateral filter, and then clipped before proceeding to the ALF. For example, an output of the joint bilateral filter and SAO filter can be expressed using the following equation:

$${I}_{OUT} = clip 3 ( {I}_{C} + Δ {I}_{BIF} + Δ {I}_{SAO} ) . \qquad ( 2 )$$

In the above expression (2), I_{OUT} denotes the output of the joint bilateral filter and SAO filter, which is also denoted as a filtered sample used as an input for subsequent ALF. I_{C} denotes an intensity of the center sample, which is also the input sample of the bilateral filter received from the de-blocking filter. ΔI_{BIF} denotes the bilateral filtering offset. ΔI_{SAO} denotes an offset value produced by the SAO filter. clip3(⋅) denotes a clipping function to make sure that the output is in the range of [min Value, max Value], which is expressed in the following equation:

$$clip 3 ( x ) = min ( max ( minValue , x ) , maxValue ) . \qquad ( 3 )$$

The implementation of bilateral filtering in the ECM provides the possibility for a video encoder to enable or disable the filtering at the CTU level and/or the slice level. The video encoder makes the decision by evaluating a rate-distortion optimization (RDO) cost. The following Table 1, Table 2, and Table 3 provide a picture parameter set (PPS) raw byte sequence payload (RBSP) syntax, a slice header syntax, and a coding tree unit syntax for a bilateral filter, respectively.

TABLE 1
PPS RBSP syntax for bilateral filter

| | Descriptor |
|---|---|
| pic_parameter_set_rbsp( ) { | |
| ... | |
| pps_bilateral_filter_enabled_flag | u(1) |
| if( pps_bilateral_filter_enabled_flag) { | |
| bilateral_filter_strength | u(2) |
| bilateral_filter_qp_offset | se(v) |
| } | |

In Table 1, if a parameter pps_bilateral_filter_enabled_flag is equal to 0, it specifies that the bilateral filter is disabled for slices referring to the PPS. If the parameter pps_bilateral_filter_enabled_flag is equal to 1, it specifies that the bilateral filter is enabled for slices referring to the PPS. A parameter bilateral_filter_strength specifies a bilateral filter strength value used in the bilateral transform block filter process. The value of bilateral_filter_strength can be in the range of 0 to 2, inclusive. A parameter bilateral_filter_qp_offset specifies an offset used in the derivation of the bilateral filter look-up table, LUT(x), for slices referring to the PPS. The parameter bilateral_filter_qp_offset can be in the range of −12 to +12, inclusive.

TABLE 2
Slice header syntax for bilateral filter

| | Descriptor |
|---|---|
| slice_header( ) { | |
| ... | |
| if( pps_bilateral_filter_enabled_flag ) { | |
| slice_bilateral_filter_all_ctb_enabled_flag | u(1) |
| if( !slice_bilateral_filter_all_ctb_enabled_flag ) | |
| slice_bilateral_filter_enabled_flag | u(1) |
| } | |

TABLE 3
Coding tree unit syntax for bilateral filter

| | Descriptor |
|---|---|
| coding_tree_unit( ) { | |
| ... | |
| if( !slice_bilateral_filter_all_ctb_enabled_flag && | |
| slice_bilateral_filter_enabled_flag ) | |
| bilateral_filter_ctb_flag[ xCtb >> CtbLog2SizeY ][ yCtb >> CtbLog2SizeY ] | u(1) |

In Table 2, if a parameter slice_bilateral_filter_all_ctb_enabled_flag is equal to 1, it specifies that the bilateral filter is enabled and is applied to all CTBs in the current slice. When slice_bilateral_filter_all_ctb_enabled_flag is not present, it is inferred to be equal to 0. If a parameter slice_bilateral_filter_enabled_flag is equal to 1, it specifies that the bilateral filter is enabled and may be applied to CTBs of the current slice. When slice_bilateral_filter_enabled_flag is not present, it is inferred to be equal to slice_bilateral_filter_all_ctb_enabled_flag.

In Table 3, if bilateral_filter_ctb_flag[xCtb>>CtbLog 2SizeY][yCtb>>CtbLog 2SizeY] is equal to 1, it specifies that the bilateral filter is applied to the luma coding tree block of the coding tree unit at luma location (xCtb, yCtb). If bilateral_filter_ctb_flag [cIdx][xCtb>>CtbLog 2SizeY][yCtb>>CtbLog 2SizeY] is equal to 0, it specifies that the bilateral filter is not applied to the luma coding tree block of the coding tree unit at luma location (xCtb, yCtb). When bilateral_filter_ctb_flag is not present, it is inferred to be equal to (slice_bilateral_filter_all_ctb_enabled_flag & slice_bilateral_filter_enabled_flag).

A bilateral filtering process for a video block (e.g., a CTU) can proceed as follows. At a picture border where samples are unavailable, a bilateral filter may use extension (e.g., sample repetition) to fill in the unavailable samples. For virtual boundaries, behavior like that of SAO can be performed, i.e., no filtering occurs. When crossing horizontal CTU borders, the bilateral filter can access samples like those of the SAO filtering. As an example shown in a filter shape of FIG. 5, if a center sample I_{C} is located on the top line of a current CTU, then I_{NW}, I_{A}, and I_{NE} can be read from another CTU that is above the current CTU (e.g., just like what SAO filtering does), but I_{AA} can be padded. Therefore, no extra line buffer is needed.

The samples surrounding the center sample I_{C} inside the filter window can be referred to as neighboring samples of the center sample, and can be denoted according to FIG. 5, where A, B, L, and R stand for above, below, left, and right, respectively, and NW, NE, SW, and SE stand for northwest, northeast, southwest, and southeast, respectively. Likewise, AA stands for above-above, BB stands for below-below, LL stands for left-left, and RR stands for right-right.

Each neighboring sample (e.g., I_{A}, I_{R}, etc.) that is one step away from the center sample I_{C} may contribute to a corresponding modifier value (e.g., μ_{ΔI}_{_{A}}, μ_{ΔI}_{_{R}}, etc.), which can be calculated as follows. For instance, by taking a right neighboring sample I_{R} as an example, a difference ΔI_{R} between the sample I_{R} and the center sample I_{C} can be calculated using the following equation:

$$Δ {I}_{R} = ( \vert {I}_{R} - {I}_{C} \vert + 4 ) ≫ 3. \qquad ( 4 )$$

In the above equation (4), |⋅| denotes an absolute value, and >> denotes a right shift by 3. The above equation (4) applies when the data has a 10-bit size. For data that does not have the 10-bit size, the difference ΔI_{R} between the sample I_{R} and the center sample I_{C} can be calculated using the following equation:

$$Δ {I}_{R} = ( \vert {I}_{R} - {I}_{C} \vert + {2}^{n - 6} ) ≫ ( n - 7 ) . \qquad ( 5 )$$

In the above equation (5), n represents the number of the bits (e.g., n=8 for 8-bit data). Then, the difference ΔI_{R} can be clipped to obtain a clipped difference sI_{R} which is smaller than 16, as shown in the following equation:

$${sI}_{R} = min ( 15 , Δ {I}_{R} ) . \qquad ( 6 )$$

A modifier value μ_{ΔI}_{_{R}} for the sample I_{R} can be calculated as shown in the following equation:

$${μ}_{Δ {I}_{R}} = \{ \begin{matrix}{LUT}_{ROW} [ s {I}_{R} ] , & if {I}_{R} - {I}_{C} \geq 0 , \\ - {LUT}_{ROW} [ {sI}_{R} ] , & otherwise\end{matrix} . \qquad ( 7 )$$

In the above equation (7), LUT_{ROW}[ ] denotes an LUT which is an array of 16 values determined by a value of qpb=clip(0, 25, QP+bilateral_filter_qp_offset−17).

Similarly, by performing operations like those described above with respect to equations (4)-(7), modifier values μ_{ΔI}_{_{L}}, μ_{ΔI}_{_{A}}, and μ_{ΔI}_{_{B}} for the left, above, and below neighboring samples I_{L}, I_{A}, and I_{B} can be calculated from I_{L}, I_{A} and I_{B}, respectively. The similar description is not repeated herein.

For diagonal samples I_{NW}, I_{NE}, I_{SE}, I_{SW} and the two-steps-away samples I_{AA}, I_{BB}, I_{RR} and I_{LL} (which are two steps away from the center sample), the calculation of the modifier values also follows the above equations (4)-(6), with a modification in the above equation (7) by shifting the value by 1. For example, using the diagonal sample I_{SE} as an example, the above equation (7) is modified as shown in the following equation for the calculation of the modifier value μ_{ΔI}_{_{SE}}:

$${μ}_{Δ {I}_{SE}} = \{ \begin{matrix}{LUT}_{ROW} [ {sI}_{SE} ] ≫ 1 , & if {I}_{SE} - {I}_{C} \geq 0 , \\ - ( {LUT}_{ROW} [ {sI}_{SE} ] ≫ 1 ) , & otherwise\end{matrix} . \qquad ( 8 )$$

Similarly, the other diagonal samples I_{NW}, I_{NE}, I_{SW}, and the two-steps-away samples I_{AA}, I_{BB}, I_{RR} and I_{LL} are calculated likewise. Then, the modifier values can be summed together to generate a modifier sum mₛᵤₘ as shown in the following equation:

$${m}_{s u m} = {μ}_{Δ {I}_{A}} + {μ}_{Δ {I}_{B}} + {μ}_{Δ {I}_{L}} + {μ}_{Δ {I}_{R}} + {μ}_{Δ {I}_{N W}} + {μ}_{Δ {I}_{N E}} + {μ}_{Δ {I}_{S W}} + {μ}_{Δ {I}_{S E}} + {μ}_{Δ {I}_{A A}} + {μ}_{Δ {I}_{B B}} + {μ}_{Δ {I}_{L L}} + {μ}_{Δ {I}_{R R}} . \qquad ( 9 )$$

It is noted that μ_{ΔI}_{_{R}} equals −μ_{ΔI}_{_{A}} for the previous sample. Likewise, μ_{ΔI}_{_{A}} equals −μ_{ΔI}_{_{B}} for the sample above, and similar symmetries can be found also for the diagonal modifier values and the two-steps-away modifier values. This means that in a hardware implementation, it is sufficient to calculate the six modifier values μ_{ΔI}_{_{R}}, μ_{ΔI}_{_{B}}, μ_{ΔI}_{_{SE}}, μ_{ΔI}_{_{SE}}, μ_{ΔI}_{_{RR}}, and μ_{ΔI}_{_{BB}}, whereas the remaining six modifier values μ_{ΔI}_{_{L}}, μ_{ΔI}_{_{A}}, μ_{ΔI}_{_{NW}}, μ_{ΔI}_{_{NE}}, μ_{ΔI}_{_{LL}}, and μ_{ΔI}_{_{AA}} can be obtained from previously calculated values.

Next, the modifier sum mₛᵤₘ can be multiplied by a multiplier c (e.g., c=1, 2 or 3), which can be executed using a single adder and logical AND gates as shown in the following equation:

$${c}_{v} = {k}_{1} \& ( {m}_{s u m} ≪ 1 ) + {k}_{2} \& {m}_{s u m} . \qquad ( 10 )$$

In the above equation (10), & denotes a logical AND operation, k₁ is the most significant bit of the multiplier c, and k₂ is the least significant bit of the multiplier c. A value of the multiplier c can be obtained using a minimum block dimension D=min(width, height) as shown in the following Table 4.

TABLE 4
c parameter and the minimum size
D = min(width, height) of the block

| Block type | D ≤ 4 | 4 < D < 16 | D ≥ 16 |
|---|---|---|---|
| Intra | c = 3 | c = 2 | c = 1 |
| Inter | c = 2 | c = 2 | c = 1 |

Subsequently, a bilateral filter offset ΔI_{BIF} for the center sample I_{C} can be calculated using the following equation (11) for full strength filtering or the following equation (12) for half-strength filtering:

$$Δ {I}_{BIF} = ( {c}_{v} + 16 ) ≫ , or \qquad ( 11 )$$

$$Δ {I}_{BIF} = ( {c}_{v} + 32 ) ≫ 6. \qquad ( 12 )$$

A general formula to obtain the bilateral filter offset ΔI_{BIF} for n-bit data can be calculated using the following equations:

$${r}_{add} = {2}^{14 - n - bilateral \_ filter \_ strength} , \qquad ( 13 )$$

$${r}_{shift} = 15 - n - bilateal\_filter \_strength , \qquad ( 14 )$$

$$Δ {I}_{BIF} = ( {c}_{v} + {r}_{add} ) ≫ {r}_{shift} . \qquad ( 15 )$$

In the above equations (13)-(15), bilateral_filter_strength can be 0 or 1 and is signaled in the PPS.

In existing designs of bilateral filtering, the filtering operation is implemented with a fixed LUT. That is, the LUT is fixed (or invariant) for different video frames even though video contents in the video frames are changed. For example, in the existing designs of bilateral filtering, the LUT in the above equation (7) or (8) is invariant for different video frames having diverse video contents. Since the video contents are usually nonstationary, it can be difficult and less effective to capture the nonstationary video contents with only one fixed LUT.

Further, filter coefficients of bilateral filtering are different for samples with different distances to the center sample according to the principle of bilateral filtering. For example, with reference to FIG. 5 again, I_{R}, I_{RR}, and I_{NE} have different distances to the center sample I_{C}, and therefore the filter coefficients (e.g., look-up values) should be different for these three positions. However, in the existing designs of bilateral filtering, I_{RR} and I_{NE} may have the same contribution to the filtering result. These existing designs may simplify a design of the LUT, but sacrifice the compression efficiency of the video coding.

Consistent with the present disclosure, a video processing method and apparatus with various bilateral filtering schemes are disclosed herein to improve the coding efficiency of bilateral filtering. The compression efficiency of the video coding can also be improved. In some implementations, an adaptive bilateral filtering scheme is disclosed herein to deal with the nonstationary characteristics of the video contents, in which different LUTs are derived adaptively for different videos (or video frames). For example, the LUTs can be different for different video contents. In some implementations, a classification-based bilateral filtering scheme is disclosed herein to deal with the diverse video contents. For example, a band-based classification scheme is disclosed herein, which firstly classifies each sample to be filtered to a corresponding category according to its sample value, and then filters the sample using an LUT determined for the corresponding category. In some implementations, a position-dependent bilateral filtering scheme is disclosed herein to improve the bilateral filtering precision. Different LUTs can be designed for the samples with different distances to a center sample of a bilateral filter.

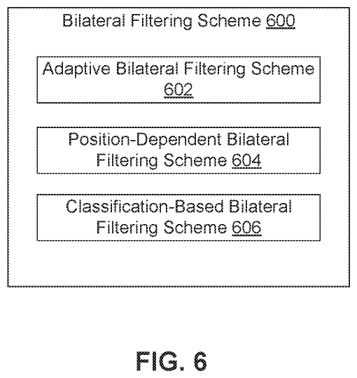

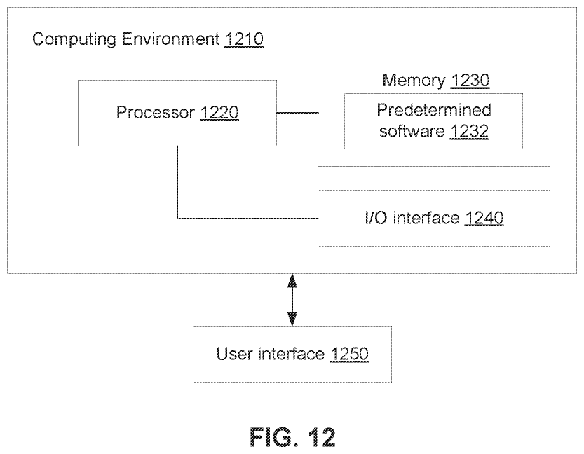

FIG. 6 is a block diagram illustrating an exemplary bilateral filtering scheme 600 in accordance with some implementations of the present disclosure. In some implementations, bilateral filtering scheme 600 of FIG. 6 can be performed by in-loop filters 63 of video encoder 20, or in-loop filters 91 of video decoder 30. In some implementations, bilateral filtering scheme 600 of FIG. 6 may be performed by a processor (e.g., a processor 1220 as shown in FIG. 12) at an encoder side or a decoder side. For illustration purpose only, the following description of FIG. 6 is provided with respect to the processor. In some implementations, bilateral filtering scheme 600 may include an adaptive bilateral filtering scheme 602, a position-dependent bilateral filtering scheme 604, or a classification-based bilateral filtering scheme 606.

With respect to an overall process of bilateral filtering scheme 600, the processor may receive a reconstructed block for in-loop filtering. The reconstructed block is reconstructed from a video block of a video frame from a video. The reconstructed block may include a plurality of reconstructed samples.

Then, the processor may apply bilateral filtering scheme 600 to the reconstructed block to generate a plurality of bilateral filtering offsets for the plurality of reconstructed samples in the reconstructed block. A bilateral filtering offset for a reconstructed sample can be denoted as ΔI_{BIF} herein. For example, the processor may apply adaptive bilateral filtering scheme 602, position-dependent bilateral filtering scheme 604, or classification-based bilateral filtering scheme 606 to generate a plurality of bilateral filtering offsets for the plurality of reconstructed samples, respectively, as described below in more detail.

Subsequently, the processor may generate a plurality of filtered samples based on the plurality of bilateral filtering offsets, respectively. For example, the processor may calculate a filtered sample I_{OUT} based on a corresponding bilateral filtering offset ΔI_{BIF} associated with a reconstructed sample according to the above equation (2). The plurality of filtered samples can be used as inputs to subsequent adaptive loop filtering.

As mentioned above, existing designs of bilateral filtering are implemented with a fixed LUT, which cannot adapt to the diverse and nonstationary property of the video contents. To address this issue, adaptive bilateral filtering scheme 602 is disclosed herein to derive different LUTs for different video frames with a least-square method. Then, the derived LUTs can be signaled in the bitstream. Specifically, the processor may apply adaptive bilateral filtering scheme 602 to generate the plurality of bilateral filtering offsets for the plurality of reconstructed samples in the reconstructed block from a video frame. For example, for each reconstructed block from the video frame, the processor may apply an LUT corresponding to the video frame to the reconstructed block to generate the plurality of bilateral filtering offsets for the plurality of reconstructed samples, respectively. The LUT can be adaptively derived from the video frame.

To begin with in a process of adaptive bilateral filtering scheme 602, for each reconstructed sample which is from the plurality of reconstructed samples and is a center sample of a bilateral filtering window, the processor may determine a set of weighting factors based on a set of neighboring samples in the bilateral filtering window. For example, the processor may apply the following Algorithm 1 to calculate a set of weighting factors associated with the center sample. Specifically, for each neighboring sample Iₚ in the bilateral filter window, the processor may calculate a clipped difference sIₚ between the sample Iₚ and the center sample I_{C} according to the above equations (4)-(6). The processor may then calculate a modifier value εₚ associated with the sample Iₚ, and then modify a value of a weighting factor n_{sI}_{ₚ} (which is a weighting factor indexed by the clipped difference sIₚ) based on the modifier value εₚ. For example, Algorithm 1 describes the following:

```
Algorithm 1: calculate a weighting factor nₖ, k = 0, 1, . . . , 15
Step 1: Initialization: nₖ = 0, k = 0, 1, . . . , 15
Step 2:
For each p in a neighboring set of {AA, NW, A, NE, LL, L, R, RR,
SW, B, SE, BB}:
  Calculate a clipped difference sIₚ between the sample Iₚ and the
  center sample I_{c} according to the above equations (4)-(6);
  Calculate a modifier value for the sample Iₚ when the sample Iₚ is
  a one-step-away sample (e.g., p = A, L, R, or B) as follows:
      ${ε}_{p} = \{ \begin{matrix}1 , & if {I}_{p} - {I}_{C} \geq 0 , \\ - 1 & otherwise .\end{matrix} \qquad ( 16 )$
    If the sample Iₚ is a diagonal sample (e.g., p = NW, NE, SW,
    or SE) or a two-steps-away sample (e.g., p = AA, LL, RR, or
    BB), then the modifier value εₚ is generated as follows:
      ${ε}_{p} = \{ \begin{matrix}0.5 , & if {I}_{p} - {I}_{C} \geq 0 , \\ - 0.5 & otherwise .\end{matrix} \qquad ( 17 )$
  Modify a weighting factor value: n_{sI}_{ₚ} += εₚ.
Return: n₀, n₁, . . . , n₁₅
```

As shown in the above equations (7)-(9), the filtering process for the center sample may need to sum up all the modifier values from its neighboring samples, with each modifier value generated based on the LUT. With respect to adaptive bilateral filtering scheme 602 disclosed herein, the processor may determine a modifier sum for the reconstructed sample (which is a center sample of the current bilateral filtering window) based on (a) the set of weighting factors derived from the above Algorithm 1 and (b) the LUT corresponding to the video frame. For example, the modifier sum can be calculated by converting the above equation (9) into the following equation:

$${m}_{s u m} = {\sum }_{k = 0}^{15} {n}_{k} \times L U T [ k ] . \qquad ( 18 )$$

In the above equation (18), LUT[k] denotes a k-th table element (e.g., a k-th entry) in the LUT corresponding to the video frame. nₖ is the weighting factor for the table element LUT[k], and can be derived depending on the neighboring samples as shown in the above Algorithm 1. mₛᵤₘ denotes the modifier sum. From the above equation (18), the modifier sum mₛᵤₘ can be calculated as a linear combination of a set of table elements LUT[k] from the LUT using the set of weighting factors nₖ, with k=0, 1, . . . , 15.

Next, the processor may determine a bilateral filtering offset for the reconstructed sample based on the modifier sum. For example, the modifier sum mₛᵤₘ can be multiplied by a multiplier c as shown in the above equation (10) to obtain a multiplied value cᵥ, and then followed by a shifting operation. The shifting operation in the above equation (11) can be converted to a division operation to obtain the bilateral filtering offset ΔI_{BIF}, as shown in the following equation:

$$Δ {I}_{BIF} = \frac{{c}_{v}}{32} . \qquad ( 19 )$$

In some implementations, the LUT can be adaptively derived from the video frame. For example, the LUT can be derived by video encoder 20 using a least-square method. It is contemplated that a target of the bilateral filtering is an original sample I_{org} corresponding to the center sample I_{C}. Therefore, an ideal bilateral filter can satisfy the following equation:

$$Δ {I}_{BIF \_ ideal} = {I}_{org} - {I}_{C} . \qquad ( 20 )$$

In the above equation (20), ΔI_{BIF_ideal} denotes an ideal bilateral filtering offset. From the above equation (18), it is observed that the bilateral filtering for each sample can be regarded as a linear combination of the table elements in the LUT. Therefore, like the adaptive loop filtering, the table elements in the LUT can be derived by a least-square method. Specifically, the processor may form a training dataset which includes a plurality of training samples. Each training sample may include a corresponding reconstructed sample, neighboring samples of the corresponding reconstructed sample, and an original sample of the corresponding reconstructed sample. The processor may apply a least-square method to train the table elements for the LUT based on the training dataset. After the table elements are derived through the training process, the LUT can be applied in the bilateral filtering operations.

For example, at the video encoder side, after the video frame is reconstructed and filtered by the deblocking filter, samples of the video frame can be selected to form a plurality of training samples in a training dataset. Each training sample may include a reconstructed sample, neighboring samples of the reconstructed sample, and the original sample of the reconstructed sample. For each training sample, an ideal bilateral filtering offset ΔI_{BIF_ideal} can be obtained according to the above equation (20). The table elements of the LUT can be determined to have values that can minimize a sum of squared errors between ideal bilateral filtering offsets (ΔI_{BIF_ideal}) and calculated bilateral offsets (ΔI_{BIF}) for the plurality of training samples. In other words, a least-square method may be used for training the LUT. In addition to the least square method, the LUT also can be trained using an iterative method. For example, the table elements can be initialized with initial values (e.g., initialized with values from a fixed LUT). Then, the table elements can be adjusted adaptively, such that a set of adjusted values that minimizes the sum of squared errors between the ideal bilateral filtering offsets (ΔI_{BIF_ideal}) and the calculated bilateral offsets (ΔI_{BIF}) for the plurality of training samples can be selected as values for the table elements in the LUT.

After the derivation of the LUT, the processor may signal the table elements of the LUT in the bitstream. In some implementations, the derived table elements can be signaled in the PPS or APS. In some implementations, the derived table elements can be coded directly and sent through the bitstream. In some implementations, the derived table elements can be predicted by corresponding table elements of a fixed LUT in the bilateral filtering, such that residuals between the derived table elements and the corresponding table elements of the fixed LUT are coded and sent through the bitstream. The derived table elements (or the residuals between the derived table elements and the corresponding table elements of the fixed LUT) can be coded using an exponential-Golomb code or any other code that is more efficient.

As mentioned above, bilateral filtering considers sample distance differences and sample intensity differences simultaneously. However, in the existing designs of bilateral filtering, samples with different distances to a center sample are handled using a single LUT, which may lead to a suboptimal filtering result. To address this issue, position-dependent bilateral filtering scheme 604 is disclosed herein to design different LUTs for the samples with different distances to the center sample. For example, neighboring samples at a one-step-away neighboring set of {A, B, L, R} (e.g., I_{A}, I_{B}, I_{L}, I_{R}) share a first LUT, neighboring samples at a two-steps-away neighboring set of {AA, BB, LL, RR} (e.g., I_{AA}, I_{BB}, I_{LL}, I_{RR}) share a second LUT, and neighboring samples at a diagonal neighboring set of {NW, NE, SW, SE} (e.g., I_{NW}, I_{NE}, I_{SW}, I_{SE}) share a third LUT. The selection of the first, second, and third LUTs for a neighboring sample is dependent on a distance between the neighboring sample and the center sample, and each of the first, second, and third LUTs can be referred to as a position-dependent LUT.

With respect to position-dependent bilateral filtering scheme 604, the processor may apply one or more position-dependent LUTs to the reconstructed block to generate a plurality of bilateral filtering offsets for a plurality of reconstructed samples in the reconstructed block. To begin with, for each reconstructed sample from the plurality of reconstructed samples which is a center sample of a bilateral filtering window, the processor may determine a plurality of modifier values for a plurality of neighboring samples in the bilateral filtering window based on the one or more position-dependent LUTs. Specifically, for each neighboring sample from the plurality of neighboring samples, the processor may determine, from the one or more position-dependent LUTs, a position-dependent LUT for the neighboring sample based on a distance between the neighboring sample and the center sample. The processor may determine a modifier value for the neighboring sample based on the position-dependent LUT.

For example, the processor may apply the above equations (4)-(8) to determine the plurality of modifier values for the plurality of neighboring samples, respectively, where the LUT in the equation (7) or (8) is selected to be a position-dependent LUT depending on a distance between a corresponding neighboring sample and the center sample. That is, when applying the equation (7) or (8), a first position-dependent LUT can be selected for the one-step-away neighboring samples I_{A}, I_{B}, I_{L}, and I_{R}; a second position-dependent LUT can be selected for the two-steps-away neighboring samples I_{AA}, I_{BB}, I_{LL}, I_{RR}; and a third position-dependent LUT can be selected for the diagonal neighboring samples I_{NW}, I_{NE}, I_{SW}, I_{SE}.

That is, the plurality of neighboring samples can be divided into one or more sample groups, with corresponding neighboring samples in each sample group having an identical distance to the center sample. For example, a first sample group may include the one-step-away neighboring samples I_{A}, I_{B}, I_{L}, and I_{R}, with the first position-dependent LUT applied to each neighboring sample in the first sample group. A second sample group may include the two-steps-away neighboring samples I_{AA}, I_{BB}, I_{LL}, I_{RR}, with the second position-dependent LUT applied to each neighboring sample in the second sample group. A third sample group may include the diagonal neighboring samples I_{NW}, I_{NE}, I_{SW}, I_{SE}, with the third position-dependent LUT applied to each neighboring sample in the third sample group.

Next, the processor may determine a modifier sum for the reconstructed sample as a sum of the plurality of modifier values. For example, the processor may apply the above equation (9) to determine the modifier sum for the reconstructed sample. Alternatively, the processor may apply the above equation (18) to determine the modifier sum for the reconstructed sample, with each table element LUT[k] being obtained from a corresponding position-dependent LUT.

Subsequently, the processor may determine a bilateral filtering offset for the reconstructed sample based on the modifier sum. For example, the processor may apply the above equations (10)-(15) to determine the bilateral filtering offset for each reconstructed sample based on the modifier sum of the reconstructed sample. Alternatively, the processor may apply the above equation (19) to determine the bilateral filtering offset for each reconstructed sample based on the modifier sum of the reconstructed sample.

In some implementations, each of the one or more position-dependent LUTs can be an LUT which is fixed for different video frames from the video. For example, the design of the fixed position-dependent LUT can follow the spirit of the bilateral filtering design in the ECM.

Alternatively, each of the one or more position-dependent LUTs can be adaptively derived from the video frame. For position-dependent bilateral filtering scheme 604, a size of a position-dependent LUT can be increased when compared to an LUT in adaptive bilateral filtering scheme 602. The derivation of table elements in the position-dependent LUT follows the similar spirit of adaptive bilateral filtering scheme 602 as described above.

For example, each of the one or more position-dependent LUTs can be determined using a least-square method described above. Specifically, for each sample group which includes corresponding neighboring samples having an identical distance to the center sample, a training dataset can be formed to include a plurality of training samples associated with the sample group. Each training sample may include a corresponding reconstructed sample in the sample group, neighboring samples of the corresponding reconstructed sample, and an original sample of the corresponding reconstructed sample. The least-square method may be applied to the training dataset to derive a set of table elements for a position-dependent LUT corresponding to the sample group.

In natural scenarios, video contents are very complex and diverse, and it is difficult to deal with all the video contents with a single filter. Instead, the video contents can be firstly classified into several categories, and each category can be handled with a corresponding filter. For example, in an adaptive loop filtering technique, a CTU can be firstly divided into several subblocks (4×4 in VVC), and each subblock can be classified into one of 25 categories according to the directionality and activity of the subblock. For each category, a corresponding filter can be derived and applied. This kind of classification can efficiently handle the processing of the diverse video contents. Following similar spirit, classification-based bilateral filtering scheme 606 is disclosed herein to improve the coding efficiency of bilateral filtering.

With respect to classification-based bilateral filtering scheme 606, the processor may initially divide the reconstructed block into a plurality of sub-blocks, and classify the plurality of sub-blocks into one or more categories. The processor may determine one or more LUTs for the one or more categories, respectively. For each reconstructed sample in a sub-block that is classified into a corresponding category, the processor may apply a LUT determined for the corresponding category to generate a bilateral filtering offset for the reconstructed sample. For example, based on the LUT determined for the corresponding category, the processor may apply the above equations (4)-(15) to generate a bilateral filtering offset for the reconstructed sample classified into the corresponding category. Alternatively, based on the LUT determined for the corresponding category, the processor may apply the above equations (18)-(19) to generate a bilateral filtering offset for the reconstructed sample classified into the corresponding category.

In some implementations, classification-based bilateral filtering scheme 606 may include a gradient and activity based classification scheme. For example, the reconstructed block can be divided into a plurality of sub-blocks, and each sub-block may be classified into a corresponding category based on a directionality and activity value of the sub-block. For each category, a corresponding LUT can be derived and applied to the subblocks belonging to the category.

In some implementations, classification-based bilateral filtering scheme 606 may include a band-based classification scheme. Specifically, the reconstructed block can be divided into a plurality of sub-blocks, and each sub-block may be classified into a corresponding category based on a band index of the sub-block. For example, a size of a sub-block can be N×N, a sample value in a sub-block is denoted as p_{i,j}, with i, j=0, 1, . . . , N−1, and a total number of bands is N_{B}. Then, a band index of the sub-block can be derived using the following equation:

$$band = int ( \frac{( {N}_{B} \times {\sum }_{i = 0}^{N - 1} {\sum }_{j = 0}^{N - 1} {p}_{i , j} )}{maxVal * N * N} ) . \qquad ( 21 )$$

In the above equation (21), maxVal denotes a maximum pixel value, and for 10-bit content, maxVal is 1023. For example, if the total number of bands is 25, and the sub-block size is 2×2, then a band index of the sub-block can be derived using the following equation:

$$band = ( 25 \times {\sum }_{i = 0}^{1} {\sum }_{j = 0}^{1} {p}_{i , j} ) \geq ( bitdepth + 2 ) . \qquad ( 22 )$$

After classifying the plurality of sub-blocks into one or more categories, a corresponding LUT for the category can be derived and applied to the sub-blocks belonging to the category. In some implementations, each of the one or more LUTs for the one or more categories can be a fixed LUT for different video frames from the video. Alternatively, each of the one or more LUTs can be adaptively derived using a least-square method described above. For example, for the adaptive derivation of an LUT for a category, training samples for each category can be collected to form a training dataset for the category. A least-square method can be applied to the training dataset to derive table elements for the LUT of the category.

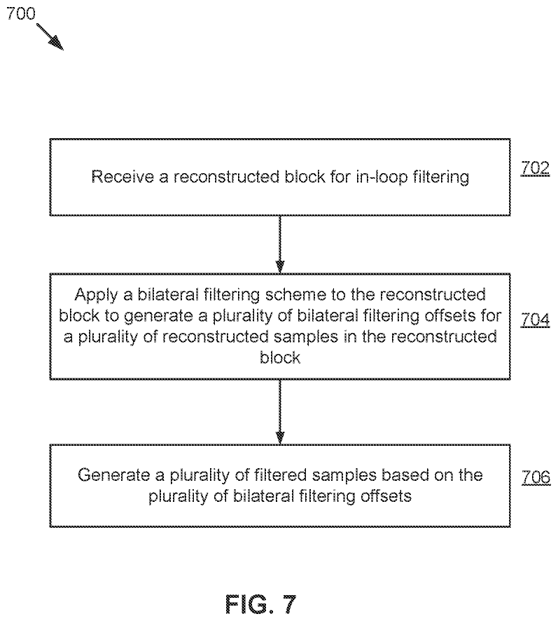

FIG. 7 is a flow chart of an exemplary method 700 for bilateral filtering in video coding in accordance with some implementations of the present disclosure. Method 700 may be implemented by a processor associated with video encoder 20 or video decoder 30, and may include steps 702-706 as described below. Some of the steps may be optional to perform the disclosure provided herein. Further, some of the steps may be performed simultaneously, or in a different order than shown in FIG. 7.

In step 702, the processor may receive a reconstructed block for in-loop filtering. The reconstructed block can be reconstructed from a video block of a video frame from a video.

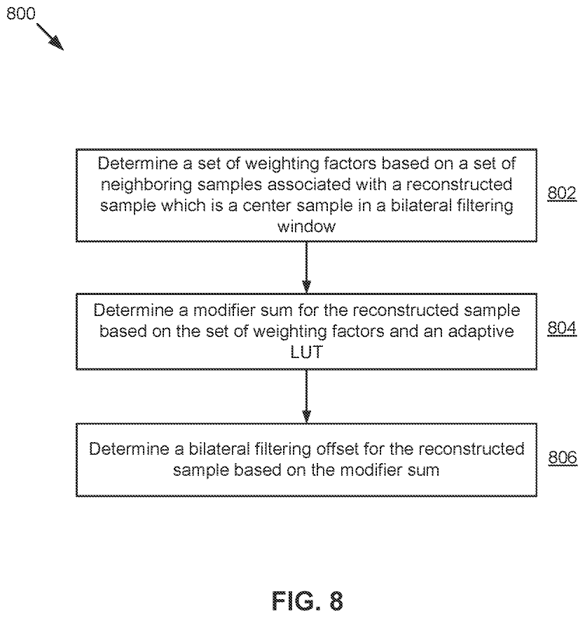

In step 704, the processor may apply a bilateral filtering scheme to the reconstructed block to generate a plurality of bilateral filtering offsets for a plurality of reconstructed samples in the reconstructed block. For example, the bilateral filtering scheme can be an adaptive bilateral filtering scheme. The processor may apply an LUT corresponding to the video frame to the reconstructed block to generate the plurality of bilateral filtering offsets for the plurality of reconstructed samples. The LUT can be adaptively derived from the video frame. An exemplary method for performing the adaptive bilateral filtering scheme is described below in more detail with reference to FIG. 8.

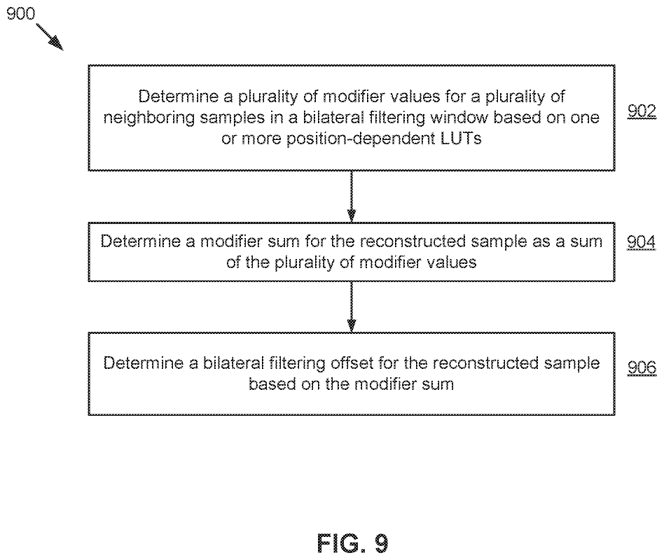

In another example, the bilateral filtering scheme can be a position-dependent bilateral filtering scheme. The processor may apply one or more position-dependent LUTs to the reconstructed block to generate the plurality of bilateral filtering offsets for the plurality of reconstructed samples. An exemplary method for performing the position-dependent bilateral filtering scheme is described below in more detail with reference to FIG. 9.

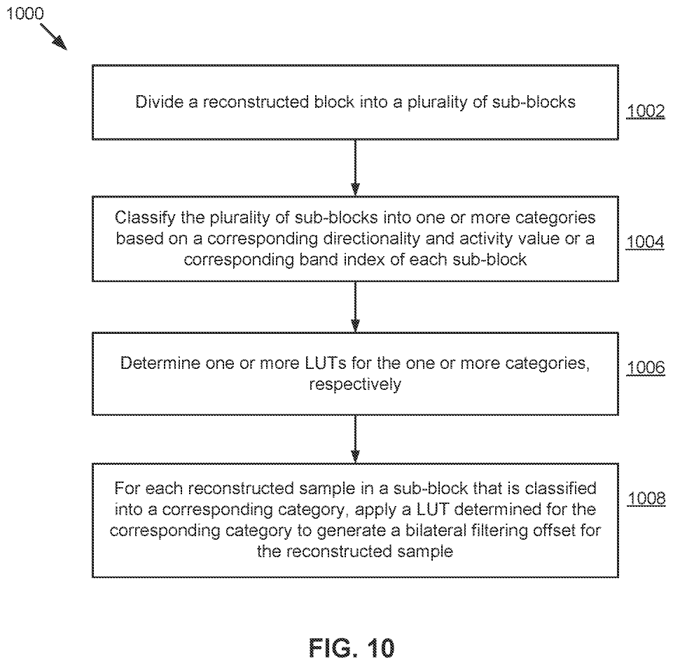

In yet another example, the bilateral filtering scheme can be a classification-based bilateral filtering scheme. The processor may divide the reconstructed block into a plurality of sub-blocks, and classify the plurality of sub-blocks into one or more categories. The processor may determine one or more LUTs for the one or more categories, respectively. For each reconstructed sample in a sub-block that is classified into a corresponding category, the processor may apply a LUT determined for the corresponding category to generate a bilateral filtering offset for the reconstructed sample. An exemplary method for performing the classification-based bilateral filtering scheme is described below in more detail with reference to FIG. 10.

In step 706, the processor may generate a plurality of filtered samples based on the plurality of bilateral filtering offsets. The plurality of filtered samples are used as inputs to subsequent adaptive loop filtering.

FIG. 8 is a flow chart of an exemplary method 800 for performing an adaptive bilateral filtering scheme to a reconstructed block in accordance with some implementations of the present disclosure. Method 800 may be implemented by a processor associated with video encoder 20 or video decoder 30, and may include steps 802-806 as described below. Some of the steps may be optional to perform the disclosure provided herein. Further, some of the steps may be performed simultaneously, or in a different order than shown in FIG. 8.

Method 800 can be an exemplary implementation of the bilateral filtering scheme in step 704 of method 700. Method 800 can be performed for each reconstructed sample from a plurality of reconstructed samples in a reconstructed block, where the reconstructed sample is a center sample of a bilateral filtering window.

In step 802, the processor may determine a set of weighting factors based on a set of neighboring samples associated with the reconstructed sample which is the center sample in the bilateral filtering window.

In step 804, the processor may determine a modifier sum for the reconstructed sample based on the set of weighting factors and an adaptive LUT corresponding to the video frame.

In step 806, the processor may determine a bilateral filtering offset for the reconstructed sample based on the modifier sum.

FIG. 9 is a flow chart of an exemplary method 900 for performing a position-dependent bilateral filtering scheme to a reconstructed block in accordance with some implementations of the present disclosure. Method 900 may be implemented by a processor associated with video encoder 20 or video decoder 30, and may include steps 902-906 as described below. Some of the steps may be optional to perform the disclosure provided herein. Further, some of the steps may be performed simultaneously, or in a different order than shown in FIG. 9.

Method 900 can be an exemplary implementation of the bilateral filtering scheme in step 704 of method 700. Method 900 can be performed for each reconstructed sample from a plurality of reconstructed samples in a reconstructed block.

In step 902, for each reconstructed sample from the plurality of reconstructed samples which is a center sample of a bilateral filtering window, the processor may determine a plurality of modifier values for a plurality of neighboring samples in the bilateral filtering window based on one or more position-dependent LUTs.

In step 904, the processor may determine a modifier sum for the reconstructed sample as a sum of the plurality of modifier values.

In step 906, the processor may determine a bilateral filtering offset for the reconstructed sample based on the modifier sum.

FIG. 10 is a flow chart of an exemplary method 1000 for performing a classification-based bilateral filtering scheme to a reconstructed block in accordance with some implementations of the present disclosure. Method 1000 can be an exemplary implementation of the bilateral filtering scheme in step 704 of method 700. Method 1000 may be implemented by a processor associated with video encoder 20 or video decoder 30, and may include steps 1002-1008 as described below. Some of the steps may be optional to perform the disclosure provided herein. Further, some of the steps may be performed simultaneously, or in a different order than shown in FIG. 10.

In step 1002, the processor may divide a reconstructed block into a plurality of sub-blocks.

In step 1004, the processor may classify the plurality of sub-blocks into one or more categories based on a corresponding directionality and activity value or a corresponding band index of each sub-block.

In step 1006, the processor may determine one or more LUTs for the one or more categories, respectively.

In step 1008, for each reconstructed sample in a sub-block that is classified into a corresponding category, the processor may apply a LUT determined for the corresponding category to generate a bilateral filtering offset for the reconstructed sample.

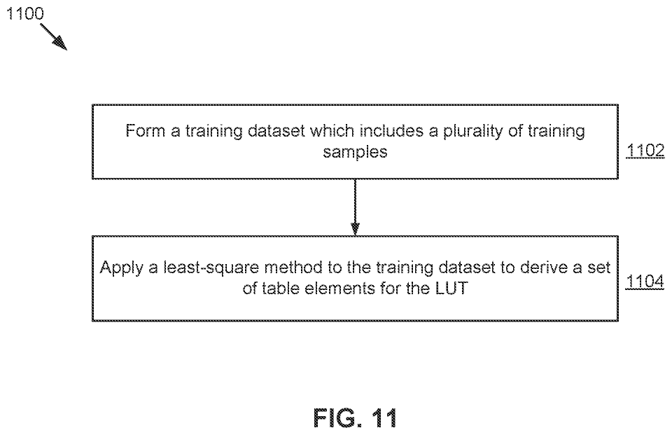

FIG. 11 is a flow chart of an exemplary method 1100 for deriving an LUT using a least-square method in accordance with some implementations of the present disclosure. Method 1100 may be implemented by a processor associated with video encoder 20 or video decoder 30, and may include steps 1102-1104 as described below. Some of the steps may be optional to perform the disclosure provided herein. Further, some of the steps may be performed simultaneously, or in a different order than shown in FIG. 11.

In step 1102, the processor may form a training dataset which includes a plurality of training samples. Each training sample may include a corresponding reconstructed sample, neighboring samples of the corresponding reconstructed sample, and an original sample of the corresponding reconstructed sample.

In step 1104, the processor may apply a least-square method to the training dataset to derive a set of table elements for the LUT. Specifically, for each training sample, an ideal bilateral filtering offset ΔI_{BIF_ideal} can be obtained according to the above equation (20). The table elements of the LUT can be determined to have values that can minimize a sum of squared errors between the ideal bilateral filtering offsets (ΔI_{BIF_ideal}) and the calculated bilateral filtering offsets (ΔI_{BIF}) for the plurality of training samples. The bilateral filtering offset ΔI_{BIF} can be calculated according to the above equation (11), (12), (15), or (19). For example, the table elements can be firstly initialized with initial values (e.g., initialized with values from a fixed LUT). Then, the table elements can be adjusted adaptively, such that a set of adjusted values that minimize the sum of squared errors between ΔI_{BIF_ideal} and ΔI_{BIF} for the plurality of training samples can be selected as values for the table elements in the LUT.

FIG. 12 shows a computing environment 1210 coupled with a user interface 1250, according to some implementations of the present disclosure. The computing environment 1210 can be part of a data processing server. The computing environment 1210 includes a processor 1220, a memory 1230, and an Input/Output (I/O) interface 1240.

The processor 1220 typically controls overall operations of the computing environment 1210, such as the operations associated with display, data acquisition, data communications, and image processing. The processor 1220 may include one or more processors to execute instructions to perform all or some of the steps in the above-described methods. Moreover, the processor 1220 may include one or more modules that facilitate the interaction between the processor 1220 and other components. The processor 1220 may be a Central Processing Unit (CPU), a microprocessor, a single chip machine, a Graphical Processing Unit (GPU), or the like.

The memory 1230 is configured to store various types of data to support the operation of the computing environment 1210. The memory 1230 may include predetermined software 1232. Examples of such data includes instructions for any applications or methods operated on the computing environment 1210, video datasets, image data, etc. The memory 1230 may be implemented by using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The I/O interface 1240 provides an interface between the processor 1220 and peripheral interface modules, such as a keyboard, a click wheel, buttons, or the like. The buttons may include but are not limited to, a home button, a start scan button, and a stop scan button. The I/O interface 1240 can be coupled with an encoder and decoder.

In some implementations, there is also provided a non-transitory computer-readable storage medium comprising a plurality of programs, for example, in the memory 1230, executable by the processor 1220 in the computing environment 1210, for performing the above-described methods. Alternatively, the non-transitory computer-readable storage medium may have stored therein a bitstream or a data stream comprising encoded video information (for example, video information comprising one or more syntax elements) generated by an encoder (for example, video encoder 20 in FIG. 2) using, for example, the encoding method described above for use by a decoder (for example, video decoder 30 in FIG. 3) in decoding video data. The non-transitory computer-readable storage medium may be, for example, a ROM, a Random Access Memory (RAM), a CD-ROM, a magnetic tape, a floppy disc, an optical data storage device or the like.

In some implementations, there is also provided a computing device comprising one or more processors (for example, the processor 1220); and the non-transitory computer-readable storage medium or the memory 1230 having stored therein a plurality of programs executable by the one or more processors, wherein the one or more processors, upon execution of the plurality of programs, are configured to perform the above-described methods.

In some implementations, there is also provided a computer program product comprising a plurality of programs, for example, in the memory 1230, executable by the processor 1220 in the computing environment 1210, for performing the above-described methods. For example, the computer program product may include the non-transitory computer-readable storage medium.

In some implementations, the computing environment 1210 may be implemented with one or more ASICs, DSPs, Digital Signal Processing Devices (DSPDs), Programmable Logic Devices (PLDs), FPGAs, GPUs, controllers, micro-controllers, microprocessors, or other electronic components, for performing the above methods.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings.

Unless specifically stated otherwise, an order of steps of the method according to the present disclosure is only intended to be illustrative, and the steps of the method according to the present disclosure are not limited to the order specifically described above, but may be changed according to practical conditions. In addition, at least one of the steps of the method according to the present disclosure may be adjusted, combined or deleted according to practical requirements.

The examples were chosen and described in order to explain the principles of the disclosure and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

What is claimed is:

1. A video processing method for bilateral filtering in video coding, comprising:
receiving, by one or more processors, a reconstructed block for in-loop filtering, wherein the reconstructed block is reconstructed from a video block of a video frame from a video;
applying, by the one or more processors, a bilateral filtering scheme to the reconstructed block to generate a plurality of bilateral filtering offsets for a plurality of reconstructed samples in the reconstructed block; and
generating, by the one or more processors, a plurality of filtered samples based on the plurality of bilateral filtering offsets, wherein the plurality of filtered samples are used as inputs to subsequent adaptive loop filtering.

2. The video processing method of claim 1, wherein the bilateral filtering scheme is an adaptive bilateral filtering scheme, wherein applying the bilateral filtering scheme to the reconstructed block comprises:
applying a look-up table (LUT) corresponding to the video frame to the reconstructed block to generate the plurality of bilateral filtering offsets for the plurality of reconstructed samples,
wherein the LUT is adaptively derived from the video frame.

3. The video processing method of claim 2, wherein applying the LUT corresponding to the video frame to the reconstructed block comprises:
for each reconstructed sample from the plurality of reconstructed samples which is a center sample of a bilateral filtering window,
determining a set of weighting factors based on a set of neighboring samples in the bilateral filtering window;
determining a modifier sum for the reconstructed sample based on the set of weighting factors and the LUT corresponding to the video frame; and
determining a bilateral filtering offset for the reconstructed sample based on the modifier sum.

4. The video processing method of claim 3, wherein determining the modifier sum comprises:
calculating the modifier sum as a linear combination of a set of table elements from the LUT based on the set of weighting factors.

5. The video processing method of claim 2, wherein:
the LUT corresponding to the video frame is derived by a video encoder; and
the LUT is signaled through a bitstream to a video decoder.

6. The video processing method of claim 5, wherein the LUT is derived by the video encoder at least by:
forming a training dataset which comprises a plurality of training samples, wherein each training sample comprises a corresponding reconstructed sample, neighboring samples of the corresponding reconstructed sample, and an original sample of the corresponding reconstructed sample; and
applying a least-square method to the training dataset to derive a set of table elements for the LUT.

7. The video processing method of claim 1, wherein the bilateral filtering scheme is a position-dependent bilateral filtering scheme, wherein applying the bilateral filtering scheme to the reconstructed block comprises:
applying one or more position-dependent look-up tables (LUTs) to the reconstructed block to generate the plurality of bilateral filtering offsets for the plurality of reconstructed samples.

8. The video processing method of claim 7, wherein applying the one or more position-dependent LUTs to the reconstructed block comprises:
for each reconstructed sample from the plurality of reconstructed samples which is a center sample of a bilateral filtering window,
determining a plurality of modifier values for a plurality of neighboring samples in the bilateral filtering window based on the one or more position-dependent LUTs;
determining a modifier sum for the reconstructed sample as a sum of the plurality of modifier values; and
determining a bilateral filtering offset for the reconstructed sample based on the modifier sum.

9. The video processing method of claim 8, wherein determining the plurality of modifier values for the plurality of neighboring samples comprises:
for each neighboring sample from the plurality of neighboring samples,
determining, from the one or more position-dependent LUTs, a position-dependent LUT for the neighboring sample based on a distance between the neighboring sample and the center sample; and
determining a modifier value for the neighboring sample based on the determined position-dependent LUT.

10. The video processing method of claim 8, wherein:
the plurality of neighboring samples are divided into one or more sample groups, with corresponding neighboring samples in each sample group having an identical distance to the center sample; and
the corresponding neighboring samples in each sample group are applied with an identical position-dependent LUT from the one or more position-dependent LUTs.

11. The video processing method of claim 7, wherein each of the one or more position-dependent LUTs is an LUT which is fixed and the same for different video frames from the video.

12. The video processing method of claim 7, wherein each of the one or more position-dependent LUTs is adaptively derived from the video frame.

13. The video processing method of claim 1, wherein the bilateral filtering scheme is a classification-based bilateral filtering scheme, wherein applying the bilateral filtering scheme to the reconstructed block comprises:
dividing the reconstructed block into a plurality of sub-blocks;
classifying the plurality of sub-blocks into one or more categories;
determining one or more look-up tables (LUTs) for the one or more categories, respectively; and
for each reconstructed sample in a sub-block that is classified into a corresponding category, applying a LUT determined for the corresponding category to generate a bilateral filtering offset for the reconstructed sample.

14. The video processing method of claim 13, wherein classifying the plurality of sub-blocks into the one or more categories comprises:
classifying each sub-block into a corresponding category based on a directionality and activity value of the sub-block.

15. The video processing method of claim 13, wherein classifying the plurality of sub-blocks into the one or more categories comprises:
classifying each sub-block into a corresponding category based on a band index of the sub-block.

16. The video processing method of claim 13, wherein each of the one or more LUTs is an LUT which is fixed and the same for different video frames from the video.

17. The video processing method of claim 13, wherein each of the one or more LUTs is adaptively derived from the video frame.

18. A video processing apparatus performing bilateral filtering in video coding, comprising:
a memory coupled to one or more processors; and
the one or more processors configured to:
receive a reconstructed block for in-loop filtering, wherein the reconstructed block is reconstructed from a video block of a video frame from a video;
apply a bilateral filtering scheme to the reconstructed block to generate a plurality of bilateral filtering offsets for a plurality of reconstructed samples in the reconstructed block; and
generate a plurality of filtered samples based on the plurality of bilateral filtering offsets, wherein the plurality of filtered samples are inputs to subsequent adaptive loop filtering.

19. The video processing apparatus of claim 18, wherein the bilateral filtering scheme is an adaptive bilateral filtering scheme, a position-dependent bilateral filtering scheme, or a classification-based bilateral filtering scheme.

20. A non-transitory computer-readable storage medium having stored therein a bitstream comprising video information to be decoded by acts comprising:
receiving a reconstructed block for in-loop filtering, wherein the reconstructed block is reconstructed from a video block of a video frame from a video;
applying a bilateral filtering scheme to the reconstructed block to generate a plurality of bilateral filtering offsets for a plurality of reconstructed samples in the reconstructed block; and
generating a plurality of filtered samples based on the plurality of bilateral filtering offsets, wherein the plurality of filtered samples are inputs to subsequent adaptive loop filtering,
wherein the video is stored in the non-transitory computer-readable storage medium.
